(19) United States
(12) Patent Application Publication
(10) Pub. No.: US 2014/0156539 A1
(43) Pub. Date: Jun. 5, 2014

(54) Device Profile-Based Rule Making for Customer Care

(71) Applicant: CrowdCare Corporation, Richmond Hill (CA)

(72) Inventors: Jeffrey Brunet, Aurora (CA); Ian Collins, Markham (CA); Karen Chan, Richmond Hill (CA)

(73) Assignee: CrowdCare Corporation, Richmond Hill (CA)

(21) Appl. No.: 13/968,631

(22) Filed: Aug. 16, 2013

Related U.S. Application Data
(60) Provisional application No. 61/684,521, filed on Aug. 17, 2012.

(51) Int. Cl. G06Q 30/00

(52) U.S. Cl. CPC G06Q 30/01
USPC 705/304

(57) ABSTRACT

A method is provided for delivering customer care to a user of a mobile device. A first device profile of the mobile device is collected. Based on aspects of this first device profile displayed on a customer care interface, and a problem report, a fix is provided to the mobile device with respect to the problem report. After the fix, a second device profile is collected. The system determines at least one difference between the first device profile and the second device profile. This difference is used to automatically generate a proto-rule for future fixes based on the problem report. In this way, automatic rule-making is possible. An editor is also provided so that the proto-rule can be edited.

### CROSS-REFERENCE TO RELATED APPLICATIONS

This application claims the benefit of U.S. Provisional Patent Application No. 61/684,521, filed Aug. 17, 2012 and entitled “Device Profile-Based Rule Making for Customer Care”, which is incorporated herein by reference in its entirety.

### FIELD OF THE INVENTION

The invention relates to customer care systems for electronic communication devices, and more particularly to systems using device profiles to provide customer care.

### BACKGROUND OF THE INVENTION

In the course of a customer care session for a device, a CSR (Customer Service Representative) must undertake the extensive and time-consuming task of asking the user complex questions pertaining to their wireless devices for problem diagnosis. This requires CSRs to be experts on many types of devices and their applications, and also requires users to spend increased time on the telephone to receive support for their applications. The result is increased support costs, increased call handling times, complex diagnostic processes and overall frustration.

The current method of gathering and obtaining device information required for diagnostics is manual and therefore complex, time-consuming and prone to human errors. This problematic approach is an ineffective method of just-in-time customer support and does not guarantee effective problem resolution. These current customer support methods leave both the users and customer support staff frustrated. In addition, obtaining diagnostic information requires a specialized support staff and contact centers must therefore hire and train specialized staff for specific tasks. For the service provider this means increased hiring and operational costs.

The customer support landscape has also changed dramatically in recent years. It used to be sufficient to train a customer support representative (CSR) on a dozen or so devices. Now, such representatives would have to understand hundreds of devices. The manual methods of training, device profiling and support simply cannot keep up with this pace of diversification.

The customer support process is increasing in complexity. Once device-specific profiles have been obtained from subscriber devices, then must begin the arduous task of identifying inconsistencies in the subscriber's configuration data in order to diagnose and resolve problems. The level of expertise required by the CSR to understand numerous devices and to search for up-to-date configuration data leads to increased costs in training, call-durations, and the overall operational costs.

More recently, automatic device profilers have become available (e.g. Smartphone Profiler, described in US Published Patent Application No. 2005/0148329, incorporated herein by reference). However, such profilers are not adapted for the next generation of wireless devices, which extends beyond smartphones into a great variety of devices (many of which have limited communication and input options). As such devices become more complex, and opaque to customers, there is a greater need for adaptive and highly-flexible customer care and greater levels of automation to handle the pace of change and the sheer number of variations of such devices and their applications. Further, potential issues need to be made more plain to CSRs and the solutions able to be provisioned automatically or with minimal client involvement. Further, the post-customer care experience (which had been a neglected domain) needs to be better tapped in order to enhance future customer care for each individual client and others with similar devices. The data bank of solutions needs to be constantly maintained and upgraded as new devices with new functionality and applications come out, presenting new challenges for devices and their users. Yet, customer care reps are not best equipped (nor do they have the time) to keep this bank updated with their “successful” problem resolutions.

There is an outstanding and unfulfilled need for automated device profiling to be taken further into generation of standardized solutions that are searchable and re-usable for device problem resolution. This would be of no small benefit to CSRs (as permitting quicker and more comprehensive resolutions) and of great benefit to users (who can receive quick and comprehensive resolutions without the agony of extensive Q and A sessions).

Further, there is a need to expand the community of support beyond customer service representatives and their discrete knowledge to embrace the wider community of experienced users, the development community and others in the “crowd”. Crowdsourcing has become a widely respected source for both originating knowledge and validation/improvement of existing data. However, the wisdom of the crowd has generally not been tapped in customer care beyond the ad hoc domains of user group discussion threads and device-related chat rooms. It would be desirable to use crowd input in a structured form to enhance customer care solutions for device issues.

### SUMMARY OF THE INVENTION

According to an aspect of the invention, a computer-implemented method is provided for providing customer care to a user of a mobile device. A first device profile of the mobile device is collected at a computing device. A problem report is received from the mobile device. Based on aspects of the first device profile displayed on a customer care interface on the computing device, a fix is provided to the mobile device with respect to the problem report. After the fix, a second device profile of the mobile device is collected at the computing device. The computing device determines at least one difference between the first device profile and the second device profile. The computing device automatically generates a proto-rule for future fixes based on the problem report and the at least one difference. An editor is provided at the computing device for editing the proto-rule.

The first device profile preferably includes a plurality of parameters, settings, statistics and applications on the device. The first device profile represents a “before” device profile. The device profile may, for example, show up on the customer care terminal as a series of statistics and facts about the device's current status, current applications, and connections. Certain problematic statistics, facts, applications and connections may be highlighted for the CSR.

Feedback may be sought from the user to determine if the fix addressed the problem report. In some embodiments, the proto-rule may be generated only if the feedback is positive. If the feedback is negative, another fix of the mobile device may be attempted (and a further device profile may be taken).

The second (i.e. “after”) device profile can be taken automatically from the device following the fix session (or upon receiving consent of the user to release some or all of the device parameters, settings and history). Such consent may require the user to say the equivalent of “yes, you can send my data again” at each instance, or the user may consent once to have profiles automatically gathered henceforth, or for periodic automatic profile gathering for ongoing issues or performance tuning. The system can compare the before and after settings, status, etc. to see what was changed. This will therefore take into account any customer changes as well as those automatically provisioned by the CSR.

Note that although the term “second device profile” is used herein, it will be appreciated that more than two profiles may be taken. The device profiles may in fact be part of a continuous chain of several device profiles that are all compared to see changes over time (or with various interventions). In some cases, it may be useful to monitor attributes over a period of time (e.g. signal strength, WiFi connectivity, Bluetooth connectivity, battery info, memory usage over time, etc.). The proto-rule may be developed over the course of these multiple profiles.

The differences between the first device profile and the second device profile may be displayed on the customer care interface.

Preferably, the proto-rule has an “IF . . . THEN” syntax. For example, the “IF” portion of the proto-rule may be based on the problem report and at least one aspect of the first device profile. The “THEN” portion of the proto-rule may be based on the at least one difference. In a general sense, the rule may have a form conceptually similar to:

IF <device type> and <problem report> and
IF <first device profile> is ....
THEN <fixes and recommendations> to make the profile look like
<second device profile>

The problem report may be part of the proto-rule (e.g. a standardized form such as <insufficient battery life> or <connection drops>).

The problem report may be an automated definition. For example, the problem may be automatically defined based on one or more elements of the first device profile that were flagged or highlighted.

The problem may also be based on the report by the user, or by observations from the customer care representative reviewing the device profile.

The method may begin in various ways. For example, the first device profile may be collected when a customer care session is initiated by the user. Alternatively, the first device profile may be collected automatically at a predetermined time (or at periodic intervals).

The “problem report” may not be a problem, as such, but simply a request for device improvement or performance enhancement (or desire to update parameters or settings or software to the most current versions).

In one embodiment, the problem report may be automatically triggered or generated on the mobile device (for example, if performance drops unexpectedly, or if there is a software crash).

The “fix” (either implemented automatically or with input from the user) may comprise changing a setting or value in the device profile. The fix may also (or in the alternative) comprise providing the mobile device with access to at least one updated software module. For example, software may be automatically provisioned or uploaded to the device, or the user may be given a link or token for retrieving software. It will be understood that “software” also includes modules, data sets, patches, libraries, etc., as well as, full applications or versions of applications.

The fix may be implemented automatically following analysis of the first device profile. The analysis and the fix may be triggered automatically or these may need to be selected or requested by a CSR (or user, in the case of selfcare).

The fix may be selectable from among a set of potential fixes displayed on the customer care interface. The recommendations and fixes may be selected from profile items automatically highlighted on the customer care interface. The recommendations and fixes may be highlighted based on past rules derived from past customer care sessions. The CSR, armed with this data and the automatic highlights generated by the system, sends automatic fixes to the customer device or suggestions to the customer to change certain things on the device (e.g. change settings, remove applications, etc.). The CSR can select the problem category and provide additional details via a notes field. This can be used to gather information to frame a future proto-rule.

Potential fixes may be identified with respect to the problem report by automated analysis having regard to a rule set. In this embodiment, an edited proto-rule can be implemented such that the rule becomes part of the rule set used to identify potential fixes.

When the first and second device profiles are compared by the system, the system identifies what was changed in the interim. The change (or delta) between the profiles is used to form a proto-rule. The changed settings become part of a proto-rule used to enhance the highlighting function of the system for future experiences with this customer or with similar devices.

In one embodiment, the proto-rule is made available for editing by users distributed across a communications network.

The proto-rule may be further validated or refined with input from the customer care representative or organization, or with input from the user (e.g. satisfaction with the response may govern whether the rule is kept at all). Crowd input may also be received with respect to the rule (e.g. other users' experiences with this type of problem or this type of solution on similar devices). The proto-rule can also be further enhanced by comparison with other proto-rules, and by validation over time as the proto-rule goes on to be implemented in other customer care sessions. If used in successful sessions, the proto-rule may be validated. Unsuccessful or unpopular proto-rules may also be weeded out.

In at least one embodiment, the customer care session may be completely automated (i.e. a self-care session) in which there is no customer care representative, and user sees the recommendations and implements them directly (or fixes may be automatically provisioned to the device without significant user input).

It will be appreciated that the recommendations and fixes may be based on device profile aspects unrelated to the original problem report. Further, the recommendations and fixes may not address any specific problem, but may simply be suggestions to get better performance out of the device, extend battery life, maximize storage, reduce data plan charges, or improve security.

These types of “optimization” or “enhancement” recommendations may be derived from information from the manufacturer, network carrier, or input from the crowd.

The device profiles are preferably received automatically from the device, and do not rely on any re-keying of information by the user or the customer care representative.

Fixes may also be sent by email or push notifications as suggestions to be implemented by the user.

In one embodiment, the customer care interface provides an opportunity to compare the device profile to a prior device profile from a previous customer care session. There may also be an option to automatically restore the device to the state of a previous device profile (e.g. a “reference” profile).

### BRIEF DESCRIPTION OF THE DRAWINGS

FIG. 1 is a flow chart of the method according to an embodiment of the present invention.

FIG. 2 is a block diagram illustrating system components of an embodiment of the present invention.

FIG. 3 is a screenshot of a stage in a hypothetical customer care session in accordance with an aspect of the present invention.

FIG. 4 is a screenshot of a stage in a hypothetical customer care session in accordance with an aspect of the present invention.

FIG. 5 is a screenshot of a stage in a hypothetical customer care session in accordance with an aspect of the present invention.

FIG. 6 is a screenshot of a stage in a hypothetical customer care session in accordance with an aspect of the present invention.

FIG. 7 is a screenshot of a stage in a hypothetical customer care session in accordance with an aspect of the present invention.

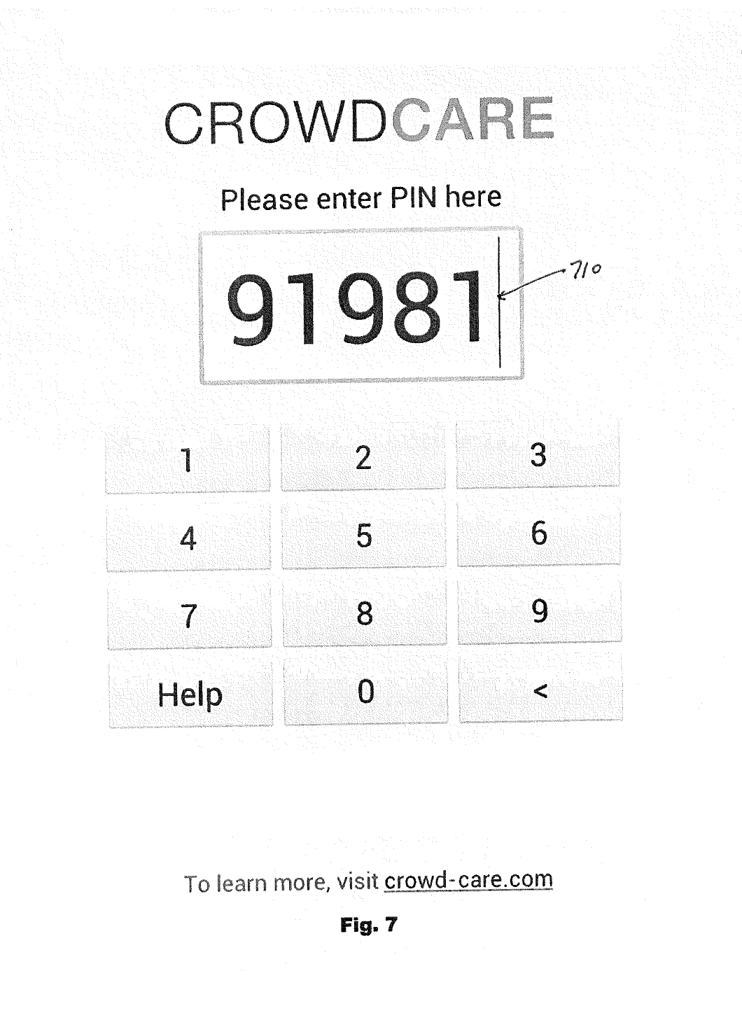

FIG. 8 is a screenshot of a stage in a hypothetical customer care session in accordance with an aspect of the present invention.

FIG. 9 is a screenshot of a stage in a hypothetical customer care session in accordance with an aspect of the present invention.

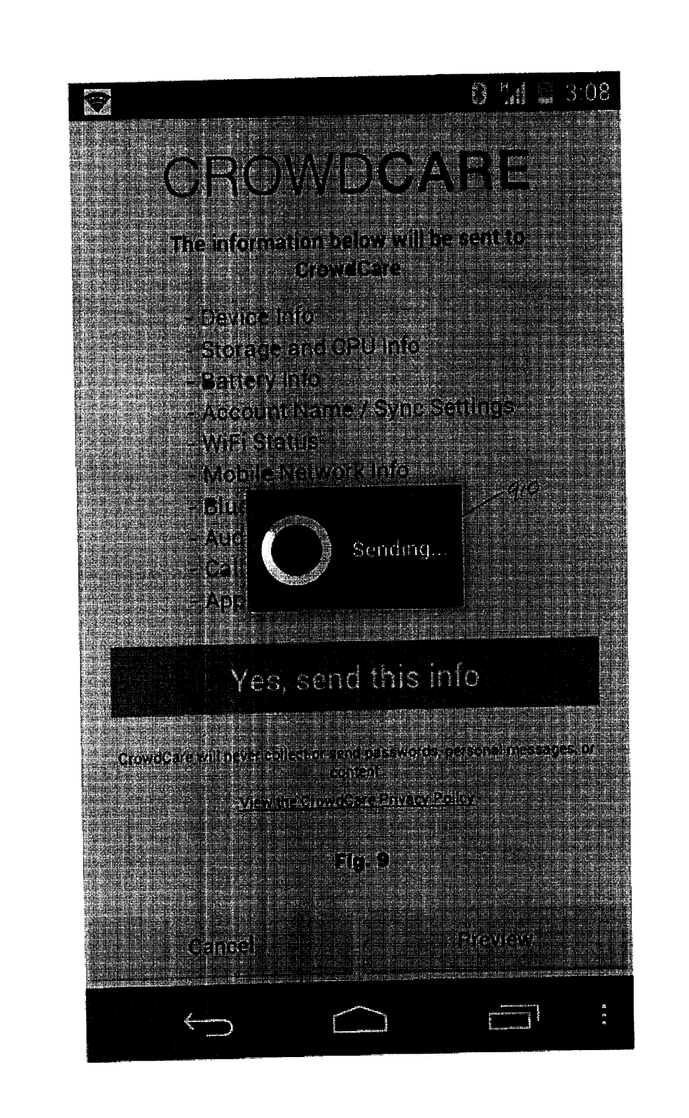

FIG. 10 is a screenshot of a stage in a hypothetical customer care session in accordance with an aspect of the present invention.

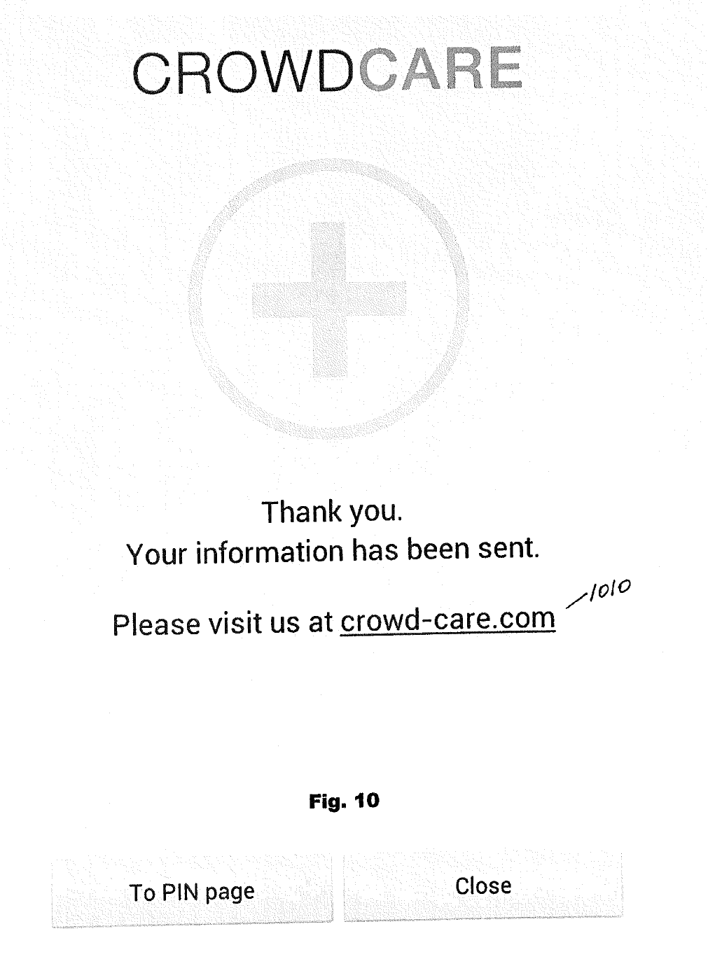

FIG. 11 is a screenshot of a stage in a hypothetical customer care session in accordance with an aspect of the present invention.

FIG. 12 is a screenshot of a stage in a hypothetical customer care session in accordance with an aspect of the present invention.

FIG. 13 is a screenshot of a stage in a hypothetical customer care session in accordance with an aspect of the present invention.

FIG. 14 is a screenshot of a stage in a hypothetical customer care session in accordance with an aspect of the present invention.

FIG. 15 is a screenshot of a stage in a hypothetical customer care session in accordance with an aspect of the present invention.

FIG. 16 is a screenshot of a stage in a hypothetical customer care session in accordance with an aspect of the present invention.

FIG. 17 is a screenshot of a stage in a hypothetical customer care session in accordance with an aspect of the present invention.

FIG. 18 is a screenshot of a stage in a hypothetical customer care session in accordance with an aspect of the present invention.

FIG. 19 is a screenshot of a stage in a hypothetical customer care session in accordance with an aspect of the present invention.

FIG. 20 is a screenshot of a stage in a hypothetical customer care session in accordance with an aspect of the present invention.

FIG. 21 is a screenshot of a stage in a hypothetical customer care session in accordance with an aspect of the present invention.

FIG. 22 is a screenshot of a stage in a hypothetical customer care session in accordance with an aspect of the present invention.

FIG. 23 is a screenshot of a stage in a hypothetical customer care session in accordance with an aspect of the present invention.

FIG. 24 is a screenshot of a stage in a hypothetical customer care session in accordance with an aspect of the present invention.

FIG. 25 is a screenshot of a stage in a hypothetical customer care session in accordance with an aspect of the present invention.

FIG. 26 is a screenshot of a stage in a hypothetical customer care session in accordance with an aspect of the present invention.

FIG. 27 is a screenshot of a stage in a hypothetical customer care session in accordance with an aspect of the present invention.

FIG. 28 is a screenshot of a stage in a hypothetical customer care session in accordance with an aspect of the present invention.

FIG. 29 is a screenshot of a stage in a hypothetical customer care session in accordance with an aspect of the present invention.

FIG. 30 is a screenshot of a stage in a hypothetical customer care session in accordance with an aspect of the present invention.

FIG. 31 is a screenshot of a stage in a hypothetical customer care session in accordance with an aspect of the present invention.

FIG. 32 is a screenshot of a stage in a hypothetical customer care session in accordance with an aspect of the present invention.

FIG. 33 is a screenshot of a stage in a hypothetical customer care session in accordance with an aspect of the present invention.

FIG. 34 is a screenshot of a stage in a hypothetical customer care session in accordance with an aspect of the present invention.

FIG. 35 is a screenshot of a stage in a hypothetical customer care session in accordance with an aspect of the present invention.

FIG. 36 is a screenshot of a stage in a hypothetical customer care session in accordance with an aspect of the present invention.

FIG. 37 is a screenshot of a stage in a hypothetical customer care session in accordance with an aspect of the present invention.

FIG. 38 is a screenshot of a stage in a hypothetical customer care session in accordance with an aspect of the present invention.

FIG. 39 is a screenshot of a stage in a hypothetical customer care session in accordance with an aspect of the present invention.

### DETAILED DESCRIPTION

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein.

The embodiments of the systems and methods described herein may be implemented in hardware or software, or a combination of both. However, preferably, these embodiments are implemented in computer programs executing on programmable computers each comprising at least one processor, a data storage system (including volatile and non-volatile memory and/or storage elements), and at least one communication interface. For example and without limitation, the programmable computers may be a server, network appliance, set-top box, smart TV, embedded device, computer expansion module, personal computer, laptop, tablet computer, personal data assistant, game device, e-reader, or mobile device (such as a smartphone). Other devices include appliances having wireless connectivity and onboard automotive devices (such as navigational and entertainment systems). Program code is applied to input data to perform the functions described herein and generate output information. The output information is applied to one or more output devices, in known fashion. In some embodiments, the communication interface may be a network communication interface. In embodiments where elements of the invention are combined, the communication interface may be a software communication interface, such as those for inter-process communication (IPC). In still other embodiments, there may be a combination of communication interfaces.

Each program is preferably implemented in a high level procedural or object oriented programming and/or scripting language to communicate with a computer system. However, the programs can be implemented in assembly or machine language, if desired. In any case, the language may be a compiled or interpreted language. Each such computer program is preferably stored on a storage media or device (e.g. ROM or magnetic diskette) readable by a general or special purpose programmable computer, for configuring and operating the computer when the storage media or device is read by the computer to perform the procedures described herein. The inventive system may also be considered to be implemented as a computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a physical computer readable medium that bears computer useable instructions for one or more processors. The medium may be provided in various forms, including one or more diskettes, compact disks, tapes, chips, magnetic and electronic storage media, and the like. The computer useable instructions may also be in various forms, including compiled and non-compiled code.

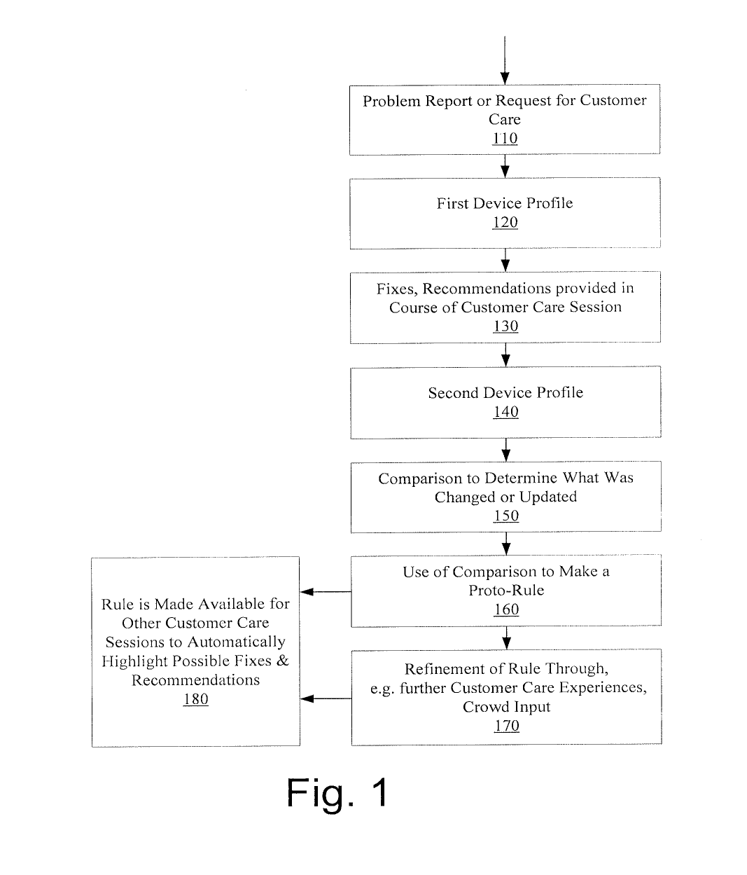

FIG. 1 outlines the basic method. As shown in FIG. 1, the method begins with a problem report of initiation of a customer care session 110. A first device profile is taken. This can be harvested directly from the device 120 (e.g. over-the-air). Next, the customer care session results in fixes and/or recommendations 130 (“fixes” is used broadly here to refer to any recommended course of action with respect to a device (including without limitation, changes in settings, installation or removal of hardware, software or firmware, physical changes, and service/plan changes)). These may be initiated by the CSR, by the user (with or without direct prompting from the CSR) or may occur automatically. Certain fixes may be implemented after the telephone or online session with the CSR, or may not occur at all (e.g. a change was suggested but not implemented).

A follow-up second (or subsequent) device profile 140 is harvested at a second point in time. The system can then compare the first and second device profiles to evaluate what was changed or updated in the device since the first profile 150 (some of the parameters may have changed due to interim activity of the device, started and stopped processes, etc., as well as changes deliberately made as a result of the customer care session). The comparison is used to arrive at a proto-rule 160. This is called a “proto-rule” because it is in a preliminary state that may require it to be refined over time. For example, the proto-rule may include as factors in the solution some changed settings that have nothing to do with the problem reported or the ultimate solution. Therefore, those irrelevant factors should be dropped from the rule in order to make it more readily useable and useful in future problem resolution.

Refinement and validation of the rule 170 (i.e. the conversion of the proto-rule to a useable rule) may be informed by comparison with other proto-rules to form more standardized or generalizable rules for use in future customer care sessions (ideally, to arrive at a rule that says “whenever this kind of problem is reported on this kind of device, under these kinds of circumstances, take this action to solve the problem”).

Crowd input can also be used to refine and improve rules.

Finally, the rules (and perhaps in some cases even proto-rules) can be made available for use in future customer care sessions 180. These rules govern what kinds of issues are highlighted on a device profile, and what recommendations or fixes are suggested automatically to the CSR.

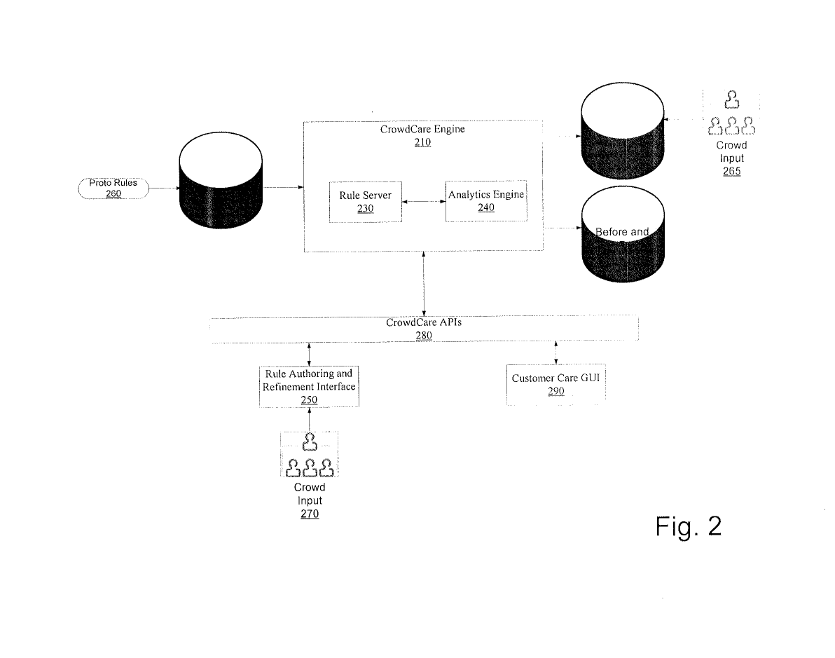

Turning now to the diagram in FIG. 2, a discussion of the system components follows. FIG. 2 shows the high-level architecture overview of the present system.

The system component referred to in this detailed description and the figures as the “CrowdCare Engine” 210 has the logic to apply rules from the Rules Repository 220 and compare device profile data with the “reference values” to identify inaccuracies and inconsistencies. The reference values may be seeded or could be from a previous profile of that device or similar devices. The CrowdCare Engine 210 includes a Rule Server 230 and Analytics Engine 240.

The Rules Repository 220 contains the domain knowledge coded in the form of rules. Generally the rules are written in a high-level business language that relates to the domain, storing the rules in the repository. Both the CrowdCare Engine 210 and the Rules Authoring and Refinement Interface 250 employ the Rules Repository 220. The Rules Repository may also include proto-rules 260 (rules not completely validated yet for implementation, which are automatically derived from comparing first and second device (or subsequent) profiles of fixed devices).

Data Stores include one or more databases used to store the “Reference Values” i.e. actual, required values for different fields (e.g. SMTP Server, Gateway IP addresses, APN, Build Versions, User name, Passwords, list of malicious apps, etc.); and gather, classify and store device profile data that has been collected from various devices over a period of time. The first and second device profiles are included in this database, as well as historical and “reference” profiles linked to specific devices.

Preferably, the system includes two data stores:

1) A CrowdCare Data Store 245 to store device “Reference Values” as they should be (this may also include reference values provided by crowd input 265); and
2) A Device Profile Data Store 255 to store device profiles as “Gathered Values” gathered from individual devices.

Preferably, the Data Stores are hosted by a JDBC-compliant database system. Connection from the application server (not shown) is preferably handled by a connection pool (not shown) where a set number of connections are established by the application server and distributed to threads requiring a database connection. Connection from the CrowdCare Engine 210 is preferably handled by a dedicated connection for each analytics engine process. Relatively static or frequently accessed data are preferably cached for enhanced performance.

Once device data is collected, the Analytics Engine 240 compares the data against both the “Reference Values” and the Rules for validation purposes and highlights the inconsistencies in the profile. For example, if the firmware version collected from the subscriber's device is v1.0 and the Analytics Engine 240 identifies the latest version to be 1.1, it is highlighted in the CSR-GUI 290. This leads to easier resolution of a customer's problem and the issue can further be resolved by uploading the latest version of the firmware to the user's device.

The CrowdCare Engine APIs 280 expose the CrowdCare Engine 210 for connecting with external components. As shown in FIG. 2, the CrowdCare Engine 210 exposes an API 280 for connectivity with any external applications either synchronously preferably using Web Services or asynchronously preferably using Web Services over Java Message Service (JMS). As an example, both the Rules Authoring Interface 250 and the CSR-GUI 290 use the CrowdCare APIs 280 for interaction with the internal components.

The Rules Authoring and Refinement Interface 250 is the mechanism of creating, deleting, and modifying rules that are stored in the Rules Repository 220. This is also used for refining proto-rules 260. This may also allow input from the crowd 270.

A rule can generally be represented as IF CONDITION(S) THEN RECOMMENDATION(S)/FIX(ES). It can consist of one or more conditions (the “IF”). One or more conditions can be grouped together by “and” and “or” and the order of operations can be further defined using brackets. In each condition, there could be a device attribute, a conditional operator (=, >, <, !=, exists, not exists) and then a text box in which to enter static text, numeric, datetime value or even another device attribute. These conditions can then be rearranged, grouped, and joined together to form a bigger condition. A rule should also contain a recommendation or a fix (the “THEN”). When saved, the rules will follow the Rules Lifecycle (status including but not limited to DRAFT, PENDING, VALIDATION, REJECTED, VALIDATED (Nth), ACTIVE, INACTIVE) and only active rules will be included in the Rules Knowledgebase for evaluation. Furthermore, the scope of a rule can be system-wide, device-specific, model-specific, manufacturer-specific, company-specific.

The Rules Authoring UI 250 could be as primitive as a form input page with drop-downs and text input boxes or could be an UI that is based off the device profile view or Comparison view where the rule author can pick and choose the conditions to build the CONDITIONS and the RECOMMENDATIONS/FIXES.

At pre-configured intervals, newly published rules can be re-evaluated against the latest device profile of end users/subscribers who opted for proactive care. A fix available notification can be pushed to the device and the device agent can connect to the CrowdCare server to fetch the new fixes.

The CSR-GUI 290 is a graphical user interface used by the Customer Service Representative for viewing and analysis of the device profile data. The CSR-GUI is preferably a web-based XML-driven dynamic system. It displays the inconsistencies found by the Analytics Engine highlighting the areas of incorrect (or potentially problematic) information.

The screens preferably use HTML5/CSS/JQuery/AJAX/JSON/JSP for layout and branding customizations. The CrowdCare server dynamically generates the screens and the relevant information based on the access-level of the Customer Service Representative. The session management and transactional logic are preferably handled via the application server using Java EE technologies (Session Beans, Web Services, JPA). By using this method, future branding and/or text changes can be made without customizations to the application logic.

The CSR-GUI 290 can present certain values as highlighted items (triggered by application of existing rules) thus allowing the CSR to quickly diagnose and resolve problems. This automated process reduces the time spent manually collecting information and therefore reduces ACHT, promoting to reduced customer care expenses.

The Analytics Engine 240 is a component of the CrowdCare Engine 210 that applies business intelligence and rules-based scenario/symptoms to identify common or known problems/inconsistencies with the user's device.

The Analytics Engine 240 works in conjunction with the Device Profiler (not shown) and is an integral module of the present system. It can be used in conjunction with the Device Profiler to present and identify current and required device information. This method of analytics and presentation greatly simplifies the overall customer care process by automatically identifying inconsistencies in a user's device settings.

Using a flexible rules-based approach, the Analytics Engine 240 can process device-specific data and correlate device profile characteristics with known problems. The Analytics Engine 240 preferably runs on its own process to connect to the main application server (not shown). The independent process enables the Analytics Engine 240 to be upgraded, load-balanced and failed-over transparently and separately from the application engine. The Analytics Engine 240 also preferably uses its own rule-compiler to allow for complex rules and filters.

The Analytics Engine 240 compares the latest information pertaining to data applications—for example, latest version numbers, device configuration settings and other configuration data required for operation of data services with the ones gathered from the device. The inconsistencies are then highlighted and presented in the CSR-GUI 290. Alternatively, or in addition, the inconsistencies may be highlighted on a display on the device itself, or otherwise presented or communicated to the subscriber, for instance, using a web application, phone, or interactive voice response (IVR) system. The transaction may be CSR-assisted or by selfcare.

The progression of the method will now be illustrated through sample screenshots of one embodiment of the customer care interface and related device interface.

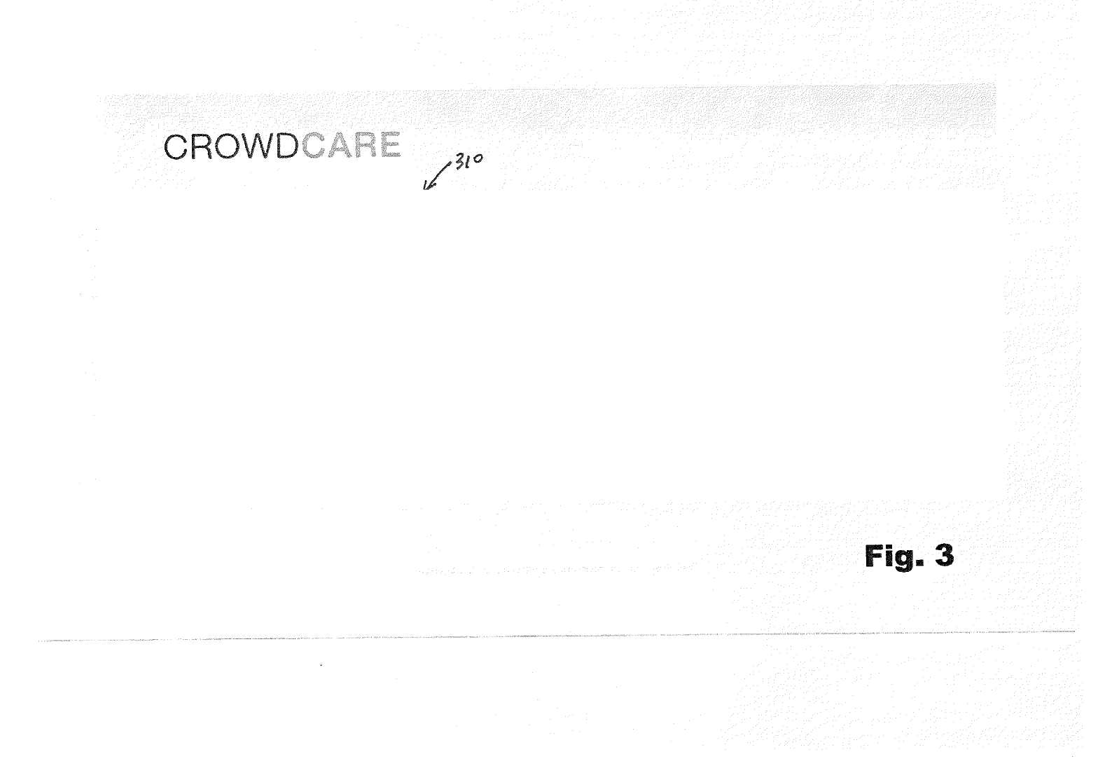

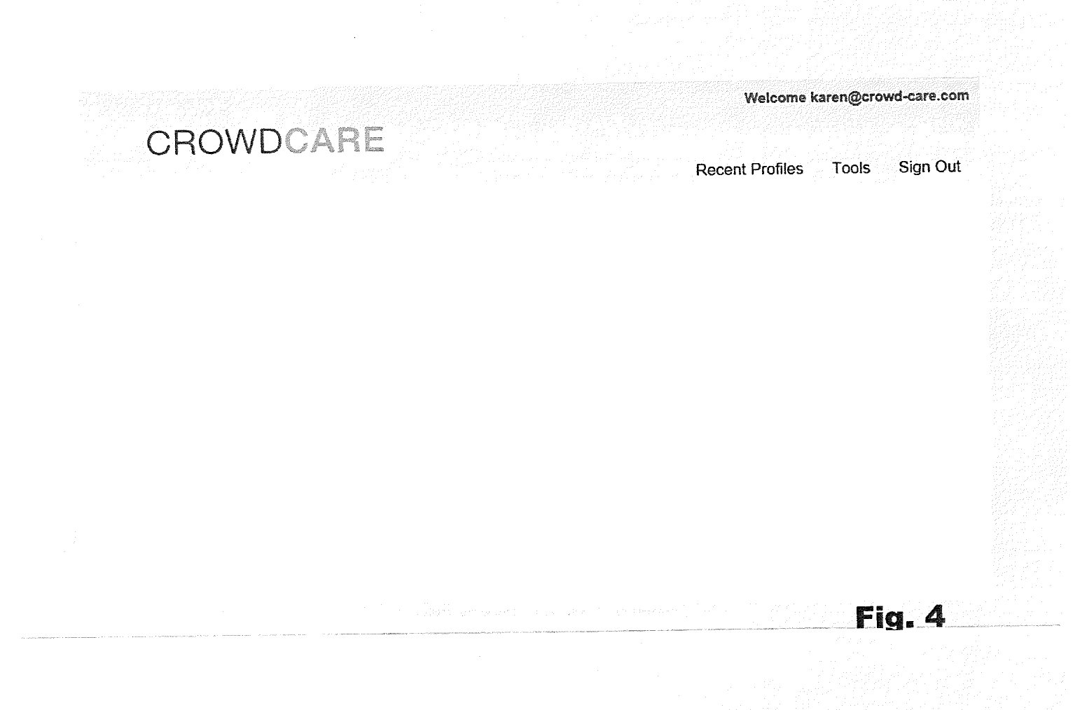

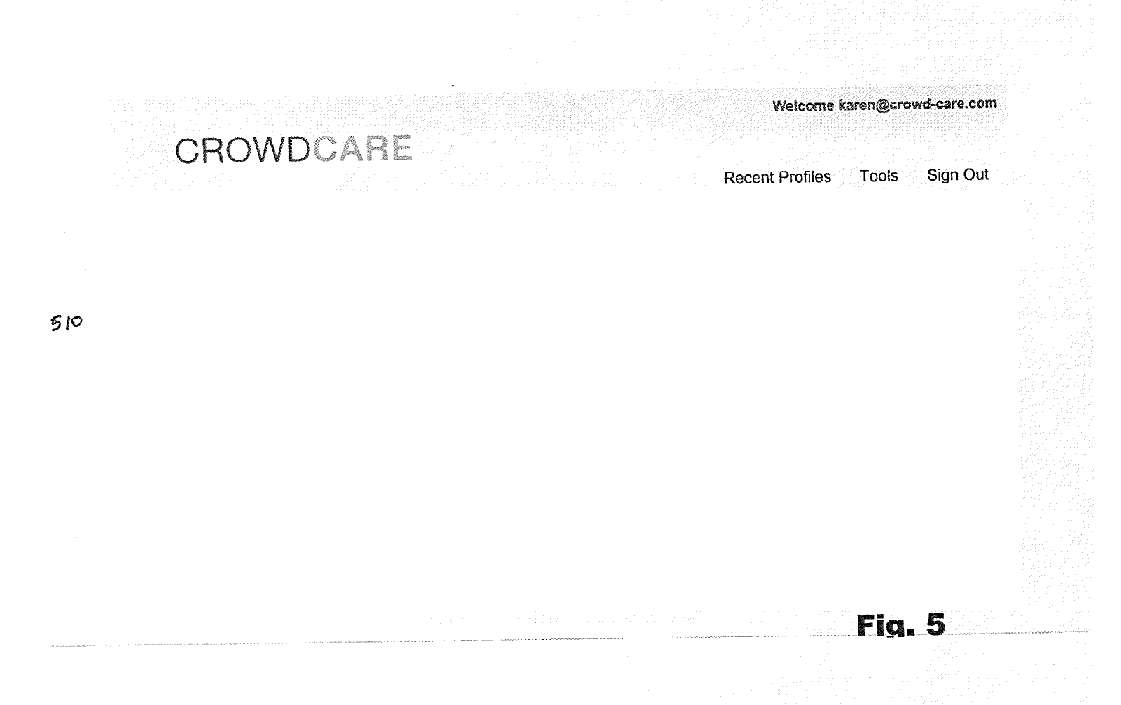

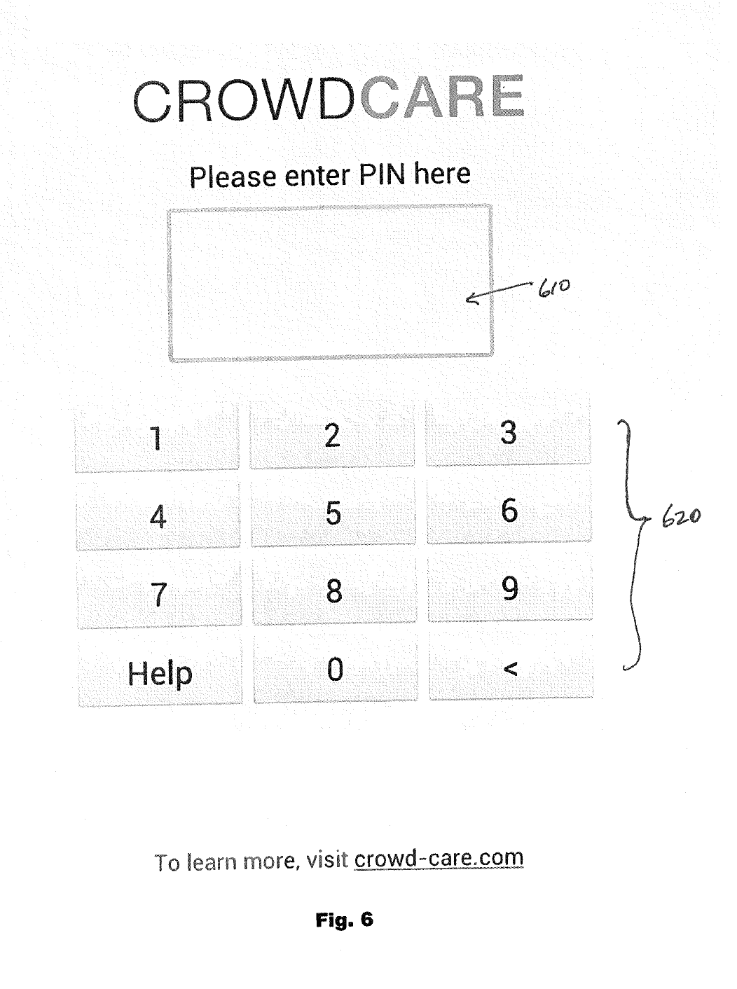

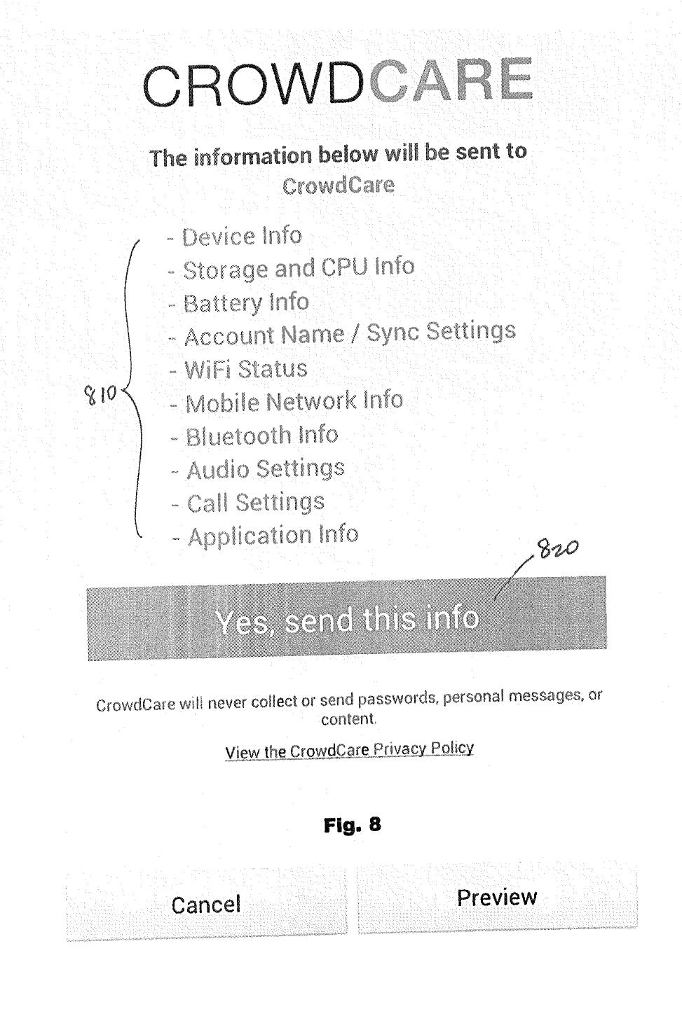

As shown in FIG. 3, the user signs into an account 310. As shown in FIG. 4, an option is given to get a PIN (generated PIN 410) in order to enter the customer care website. The PIN 510, which is provided as shown in FIG. 5 is entered on the device as shown in FIG. 6 (PIN window 610 and keypad 620) and 7 (entered PIN 710). A screen showing all of the information that will be sent to the device profiler 810 is preferably shown to the user for consent 820 (see FIG. 8).

This information may include without limitation:
device info,
storage and CPU info
battery info
account name
sync settings
WiFi status
mobile network info
Bluetooth info
audio settings
call settings
application info

The user is preferably given an opportunity to click to proceed 820 (or the profile may be gathered automatically behind the scenes, such as if consent was previously given for ongoing monitoring of a reported problem). At this point, the device data is sent 910 to the customer care profiler as shown in Figure. The device screen may also invite the user to visit a customer care page 1010.

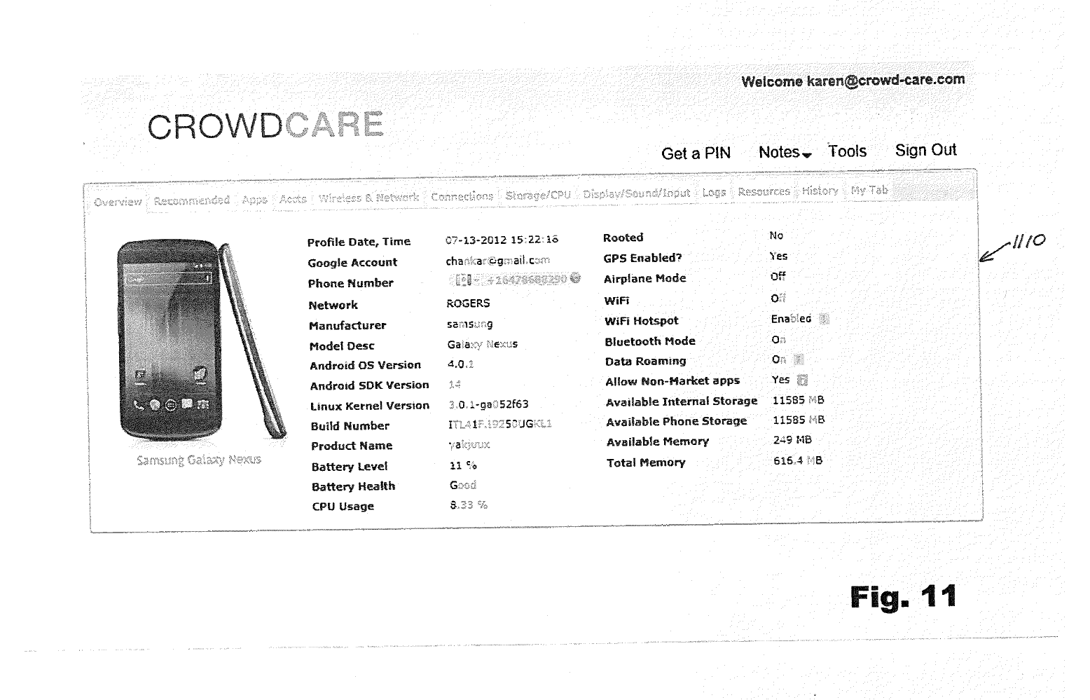

FIG. 11 begins the device profile information screens which are seen by the CSR. An overview screen 1110 as provided in FIG. 11, shows information including the manufacturer, model description, OS version, SDK version, kernel version, build number, product name, phone number, network, battery level, CPU usage, rootedness, GPS enablement, airplane mode, WiFi information, Bluetooth information, roaming status, whether non-market apps are permitted, the available internal space, available SD card space, available memory and total memory. As shown in FIG. 11, certain elements may be highlighted for the customer care representative (or the user him/herself in a self-care mode).

Note that there may be options to take a “light” initial profile and a subsequent “deeper” profile with respect to a particular area of concern (e.g. for collecting all log information, or a light profile of applications in the first round, but a deeper profile of applications in a subsequent profile). Further, it may be possible for the end-user to define what type of profile is sent. That is, the end user may be able to select what to send to the server, or preview and pick the information that is sent in the profile.

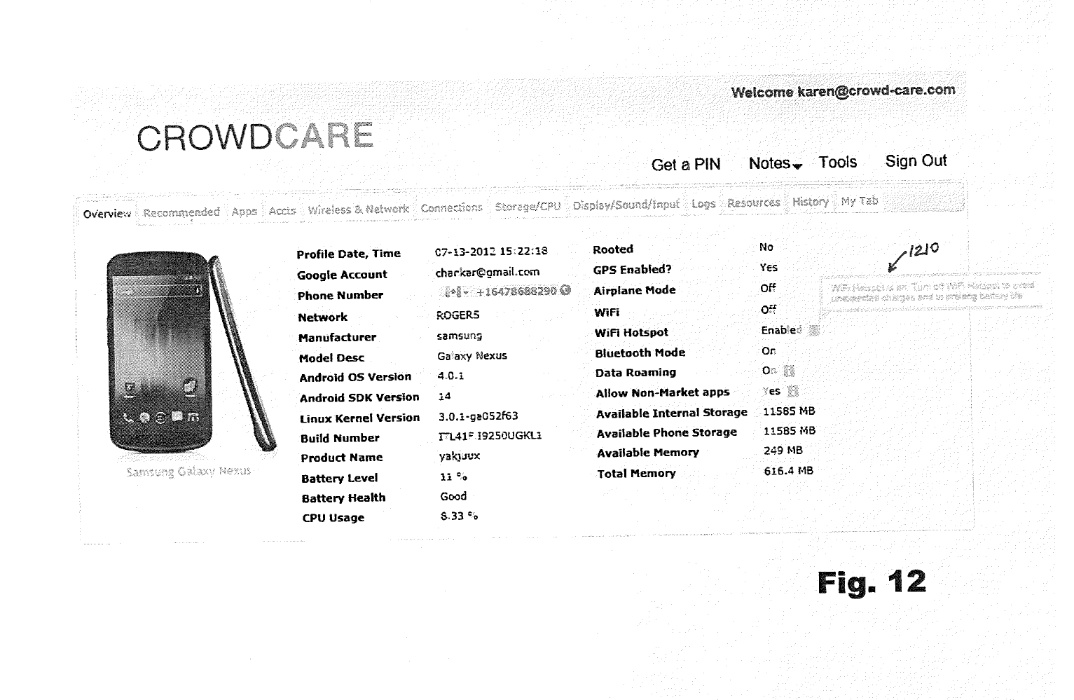

As shown in FIG. 12, the highlighted information 1210 may also include comments to direct the customer care representative or the user as to certain steps that may be taken to improve the performance of the device or address other known issues. In this case, WiFi Hotspot is highlighted, and a suggestion is made that WiFi Hotspot can be turned off to avoid unexpected charges and prolong battery life.

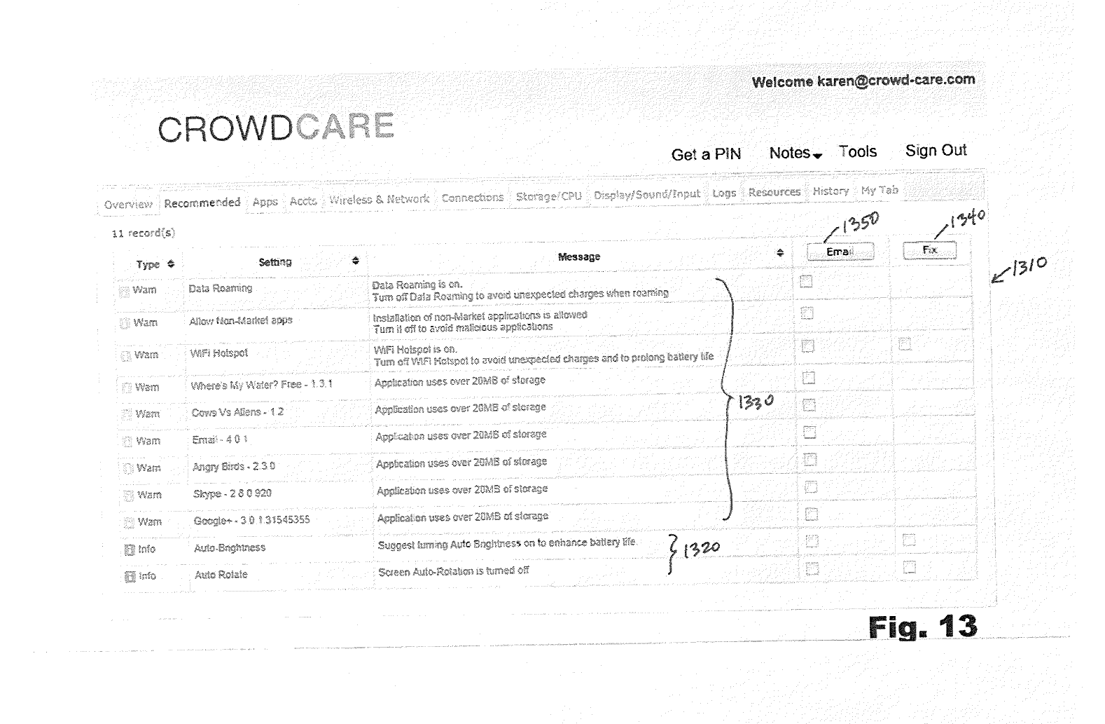

As shown in FIG. 13, a separate recommendation screen 1310 may be provided that shows specific recommendations 1320, warnings 1330 and other information to enable settings on the device to be changed, or other fixes provisioned or implemented. The option to automatically fix or provision a fix may be toggled through this screen, and/or an option may be provided to email 1350 the information to the user's device.

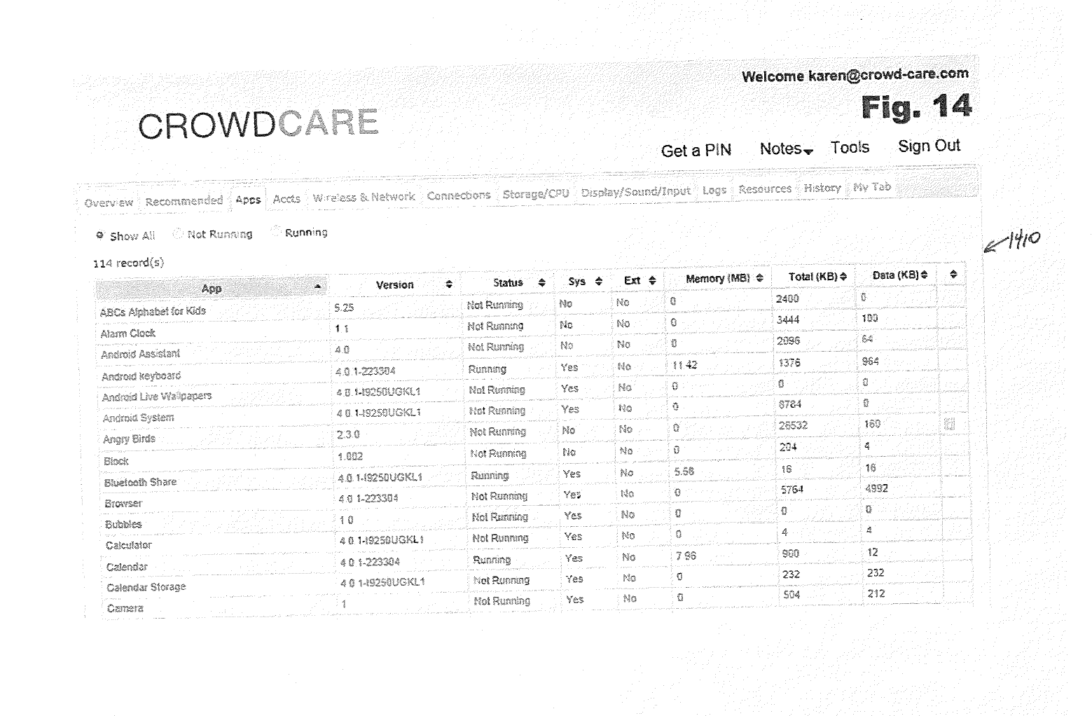

As shown in FIG. 14, a separate screen 1410 may show all of the apps currently loaded on the device and their status, version number, as well as the storage memory and data they consume. These also may include highlights if there are known to be more recent versions, bug fixes or other issues to highlight with respect to an application.

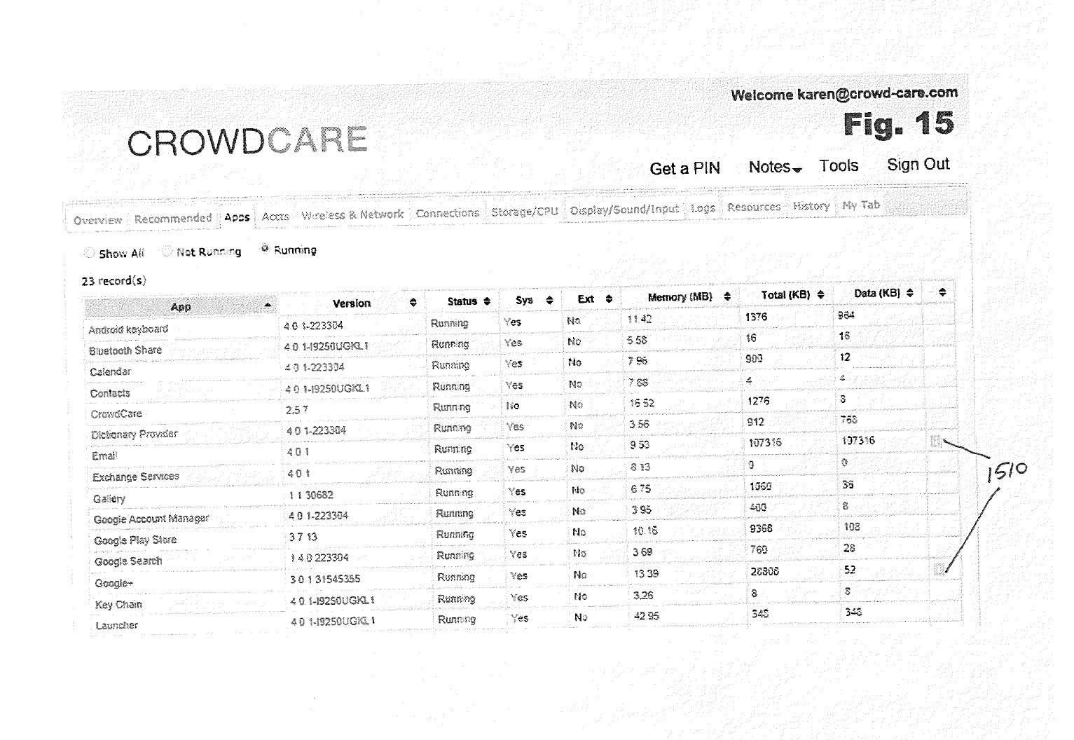

As shown in FIG. 15, certain applications may be highlighted 1510, such as if they appear to be using a large amount of storage, or if a more recent version is available.

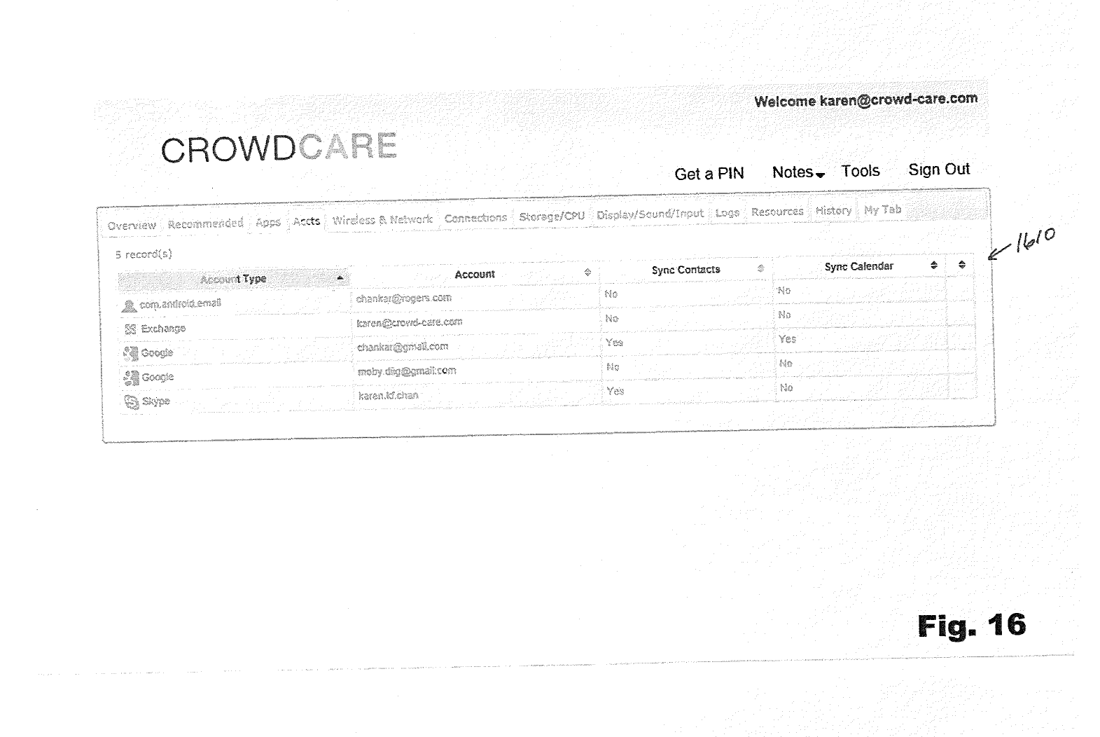

As shown in FIG. 16, a separate screen 1610 may be provided showing the email accounts and other accounts associated with the device may be shown, as well as their sync status.

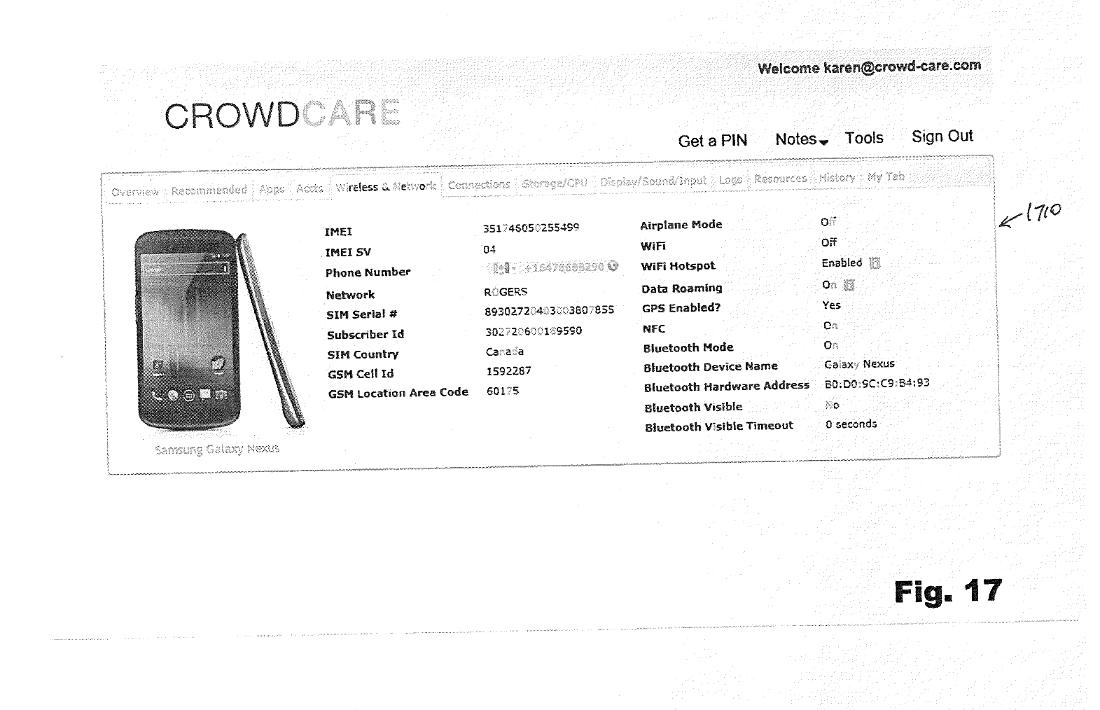

FIG. 17 shows a screen 1710 of the device profile that relates specifically to wireless and network status.

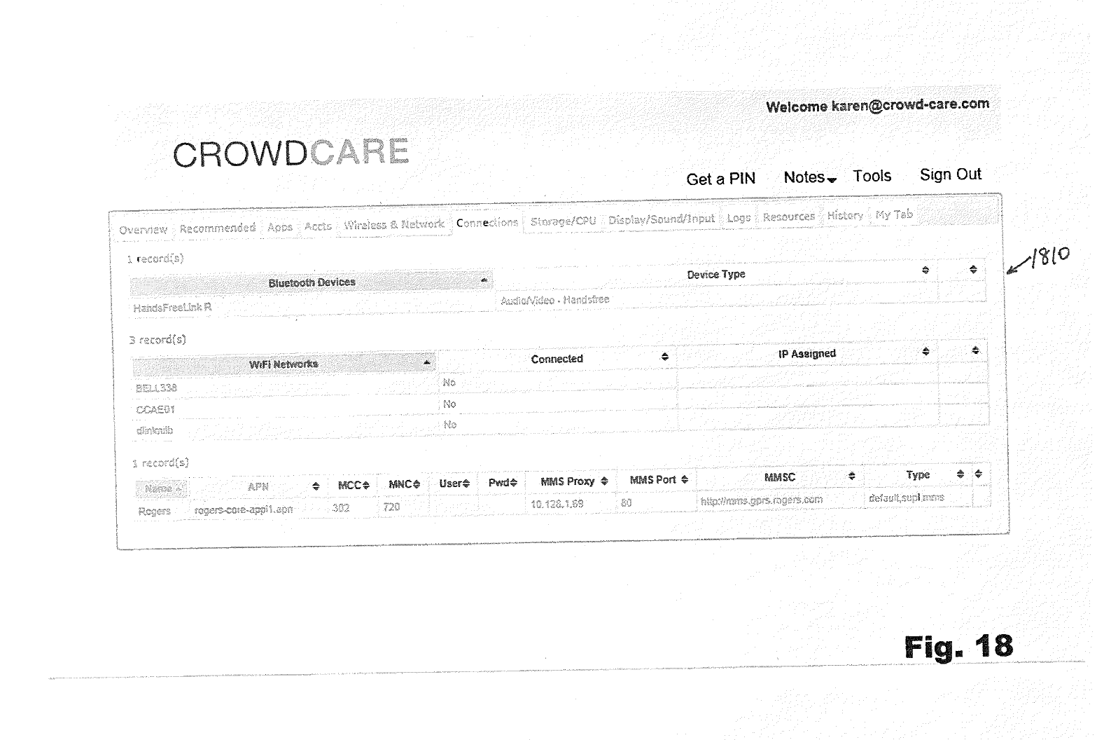

FIG. 18 shows a Connections screen 1810 showing the detailed status of various types of connections—Bluetooth, WiFi, APN, etc.

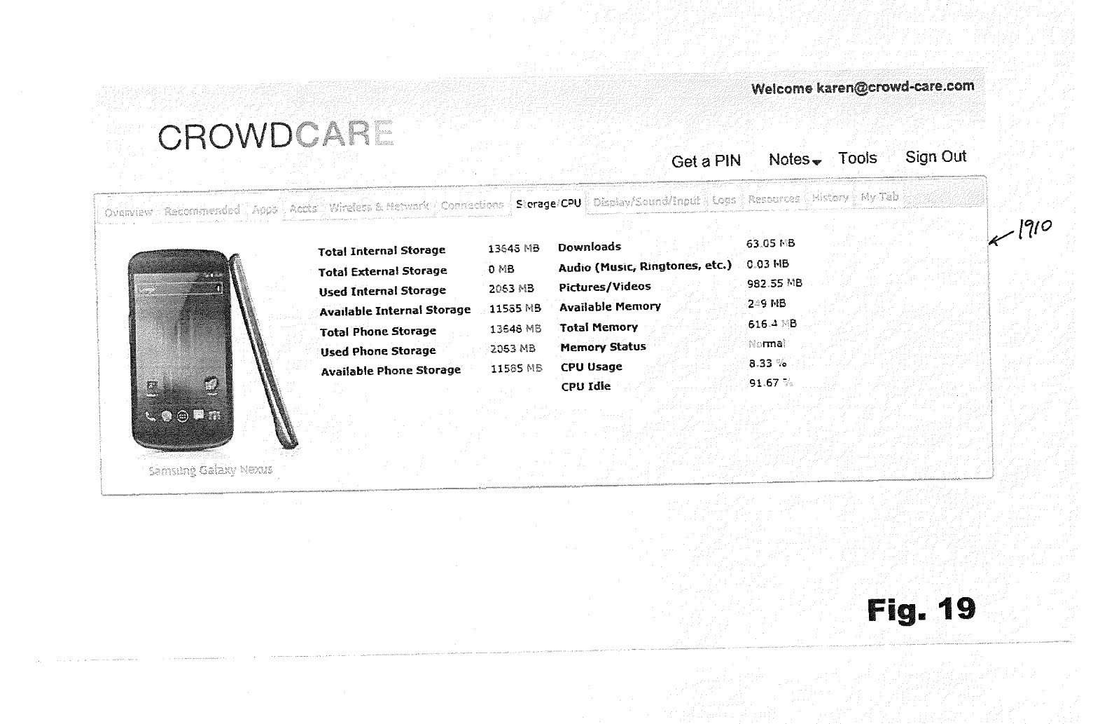

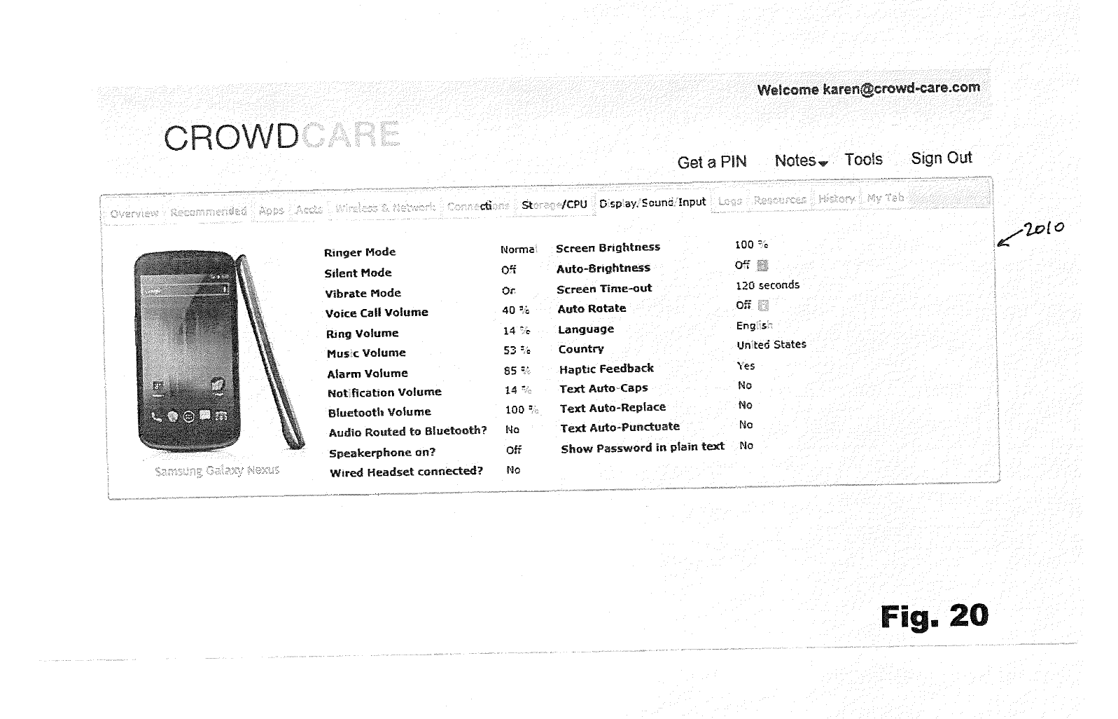

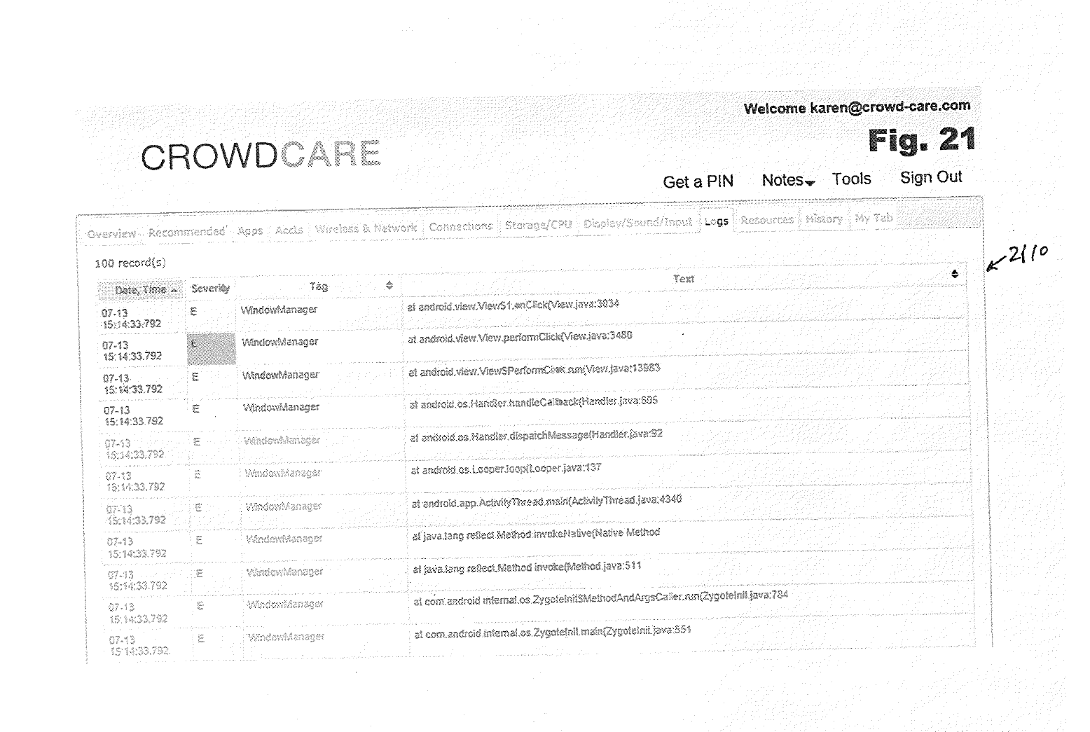

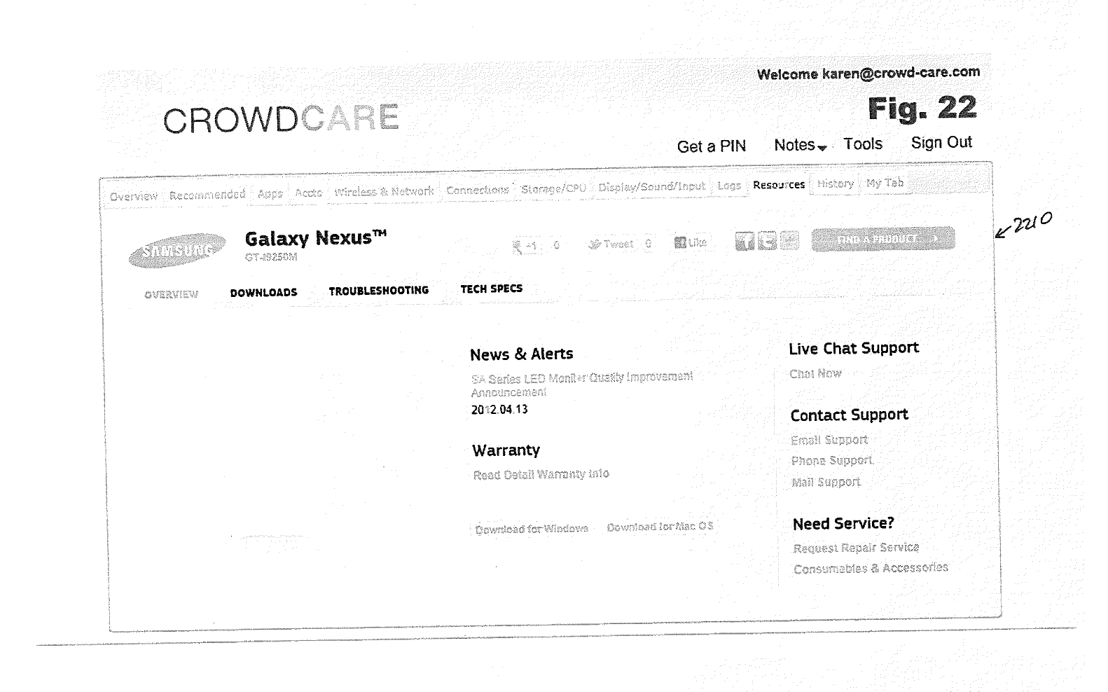

FIG. 19 shows a screen 1910 with profile information related to storage and CPU. FIG. 20 shows a screen 2010 with the device display, sound and input parameters. FIG. 21 shows a screen 2110 of logs of a sampling of faults. If deeper analysis is required, it may be possible to take a deeper subsequent profile to collect the entire log from the device (not shown). A resources screen 2210, as shown in FIG. 22, may link to update information with respect to the specific device and/or other troubleshooting information.

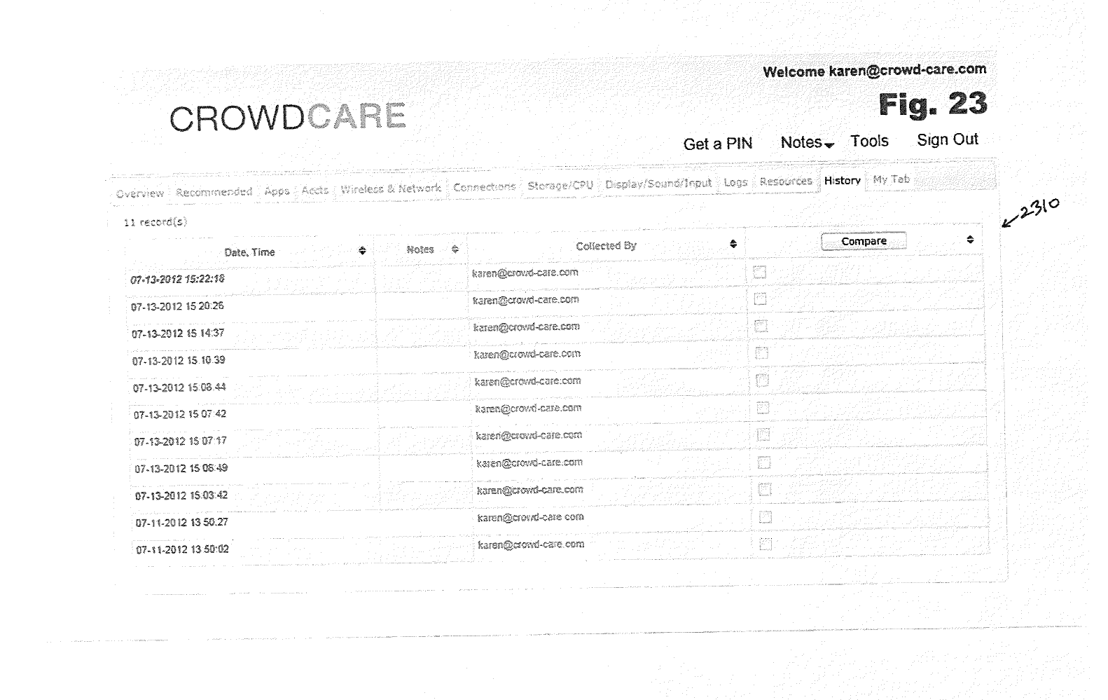

A customer care history is provided under the history screen 2310 as shown in FIG. 23. This screen also allows previous profiles to be compared. For example, a previous profile can be set as “reference profile” which can be restored on the device (not shown).

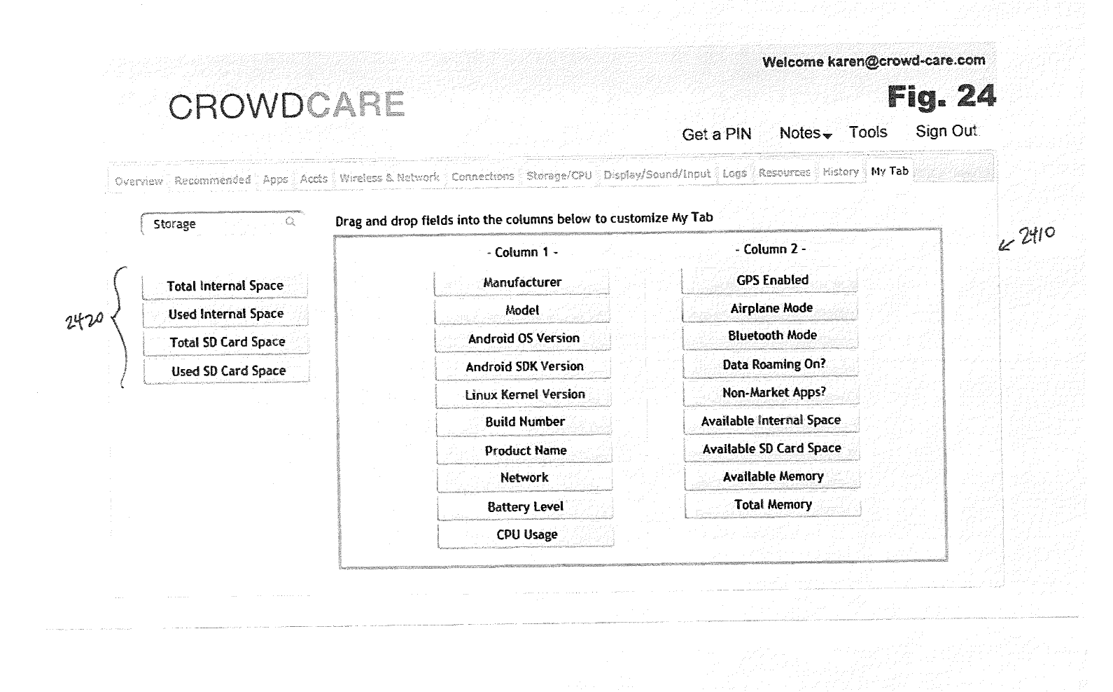

FIG. 24 (My Tab screen 2410) allows specific profile elements to be customized on the customer care screen, so that the representative can choose specific fields 2420 to look at as a sub-set of the full profile option.

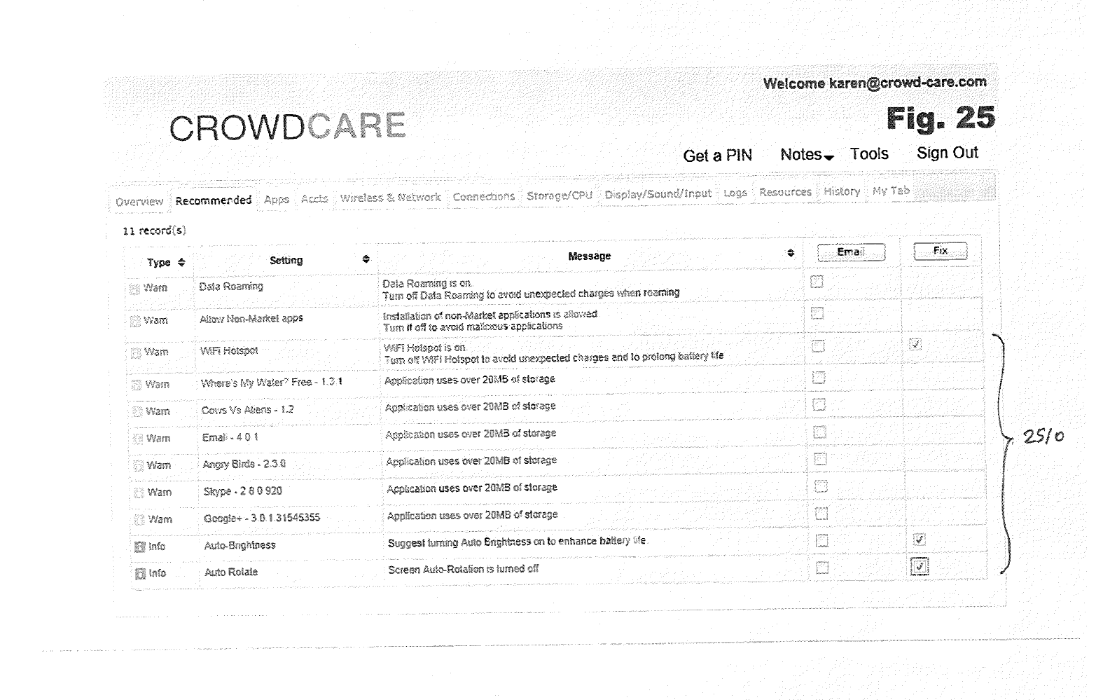

As shown in FIG. 25, the customer care representative can return to the recommendations screen to select certain fixes 2510 to be provisioned to the device. In this case, the CSR has selected to change the setting for WiFi Hotspot and also turn on the setting for auto-adjust brightness in order to enhance the battery life.

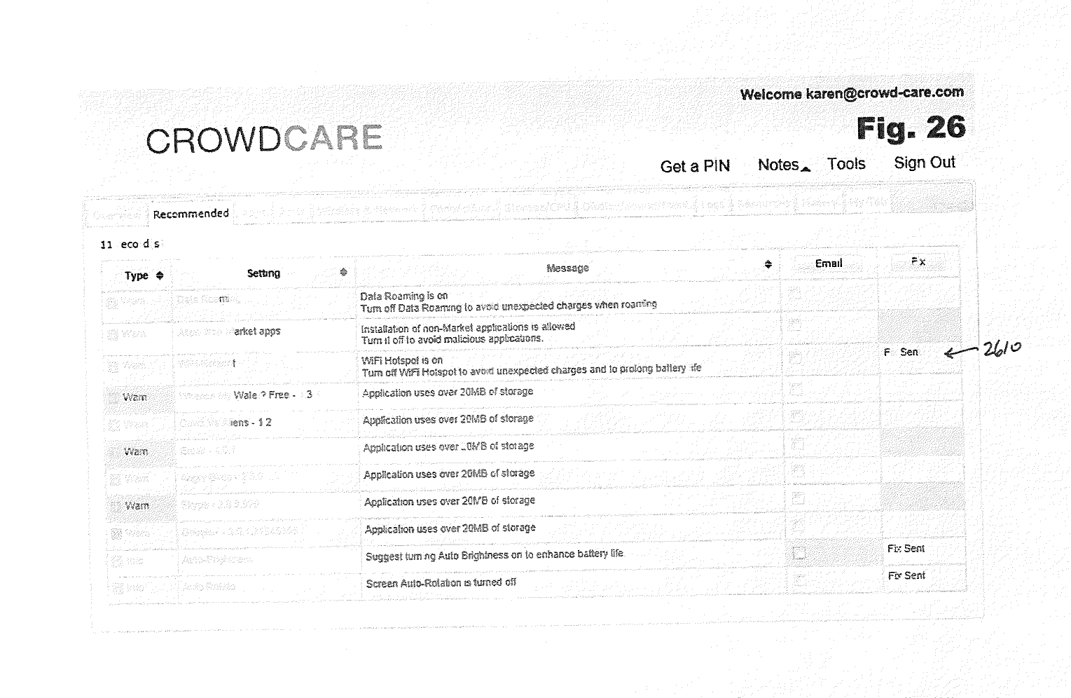

As shown in FIG. 26, the fixes were automatically sent 2610 to the device.

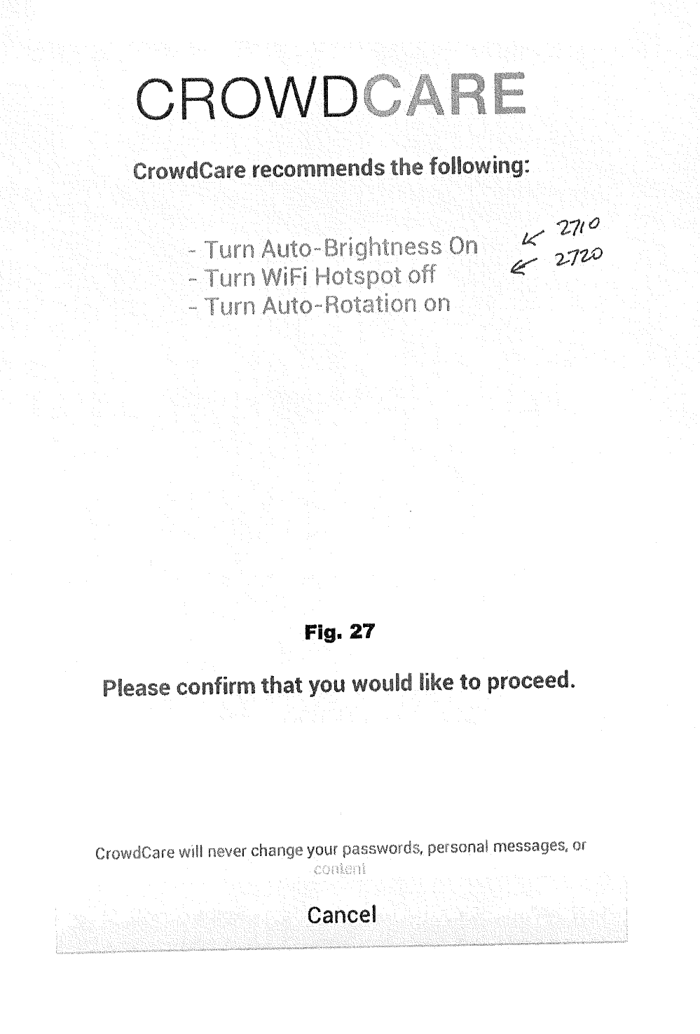

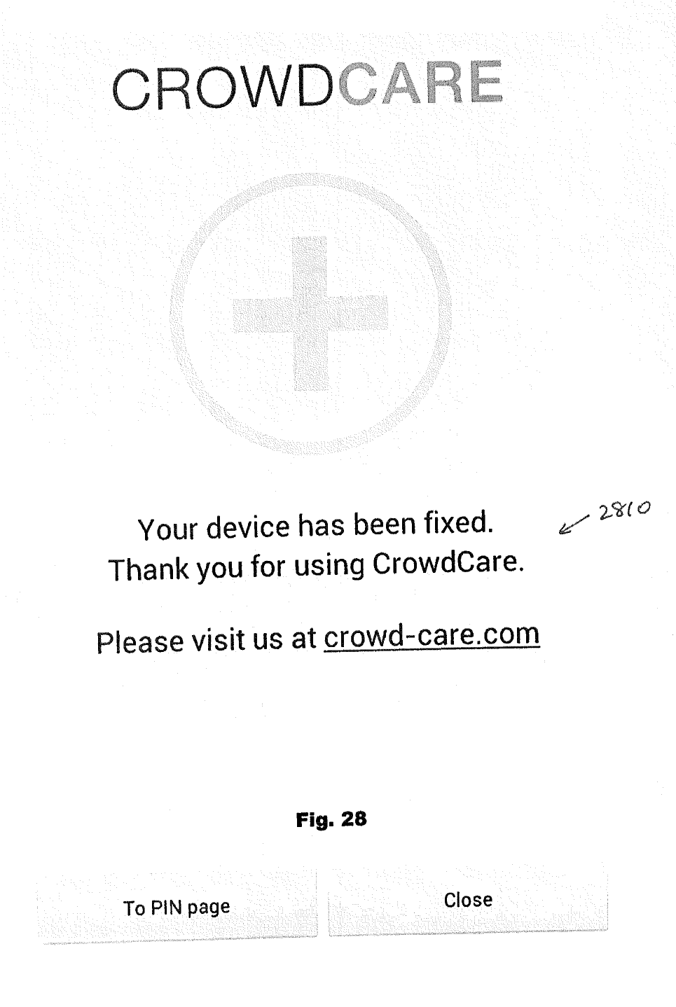

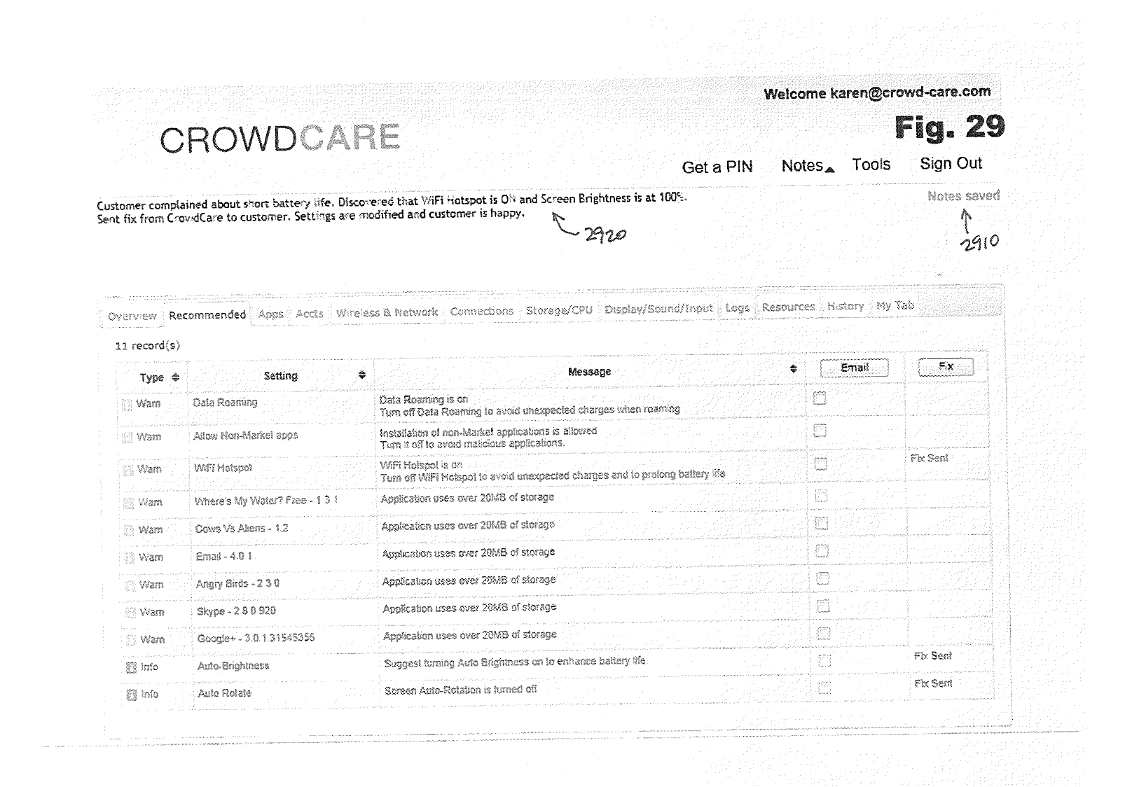

FIG. 27 shows the view from the device itself, showing that the auto-brightness was turned on 2710 and WiFi Hotspot was turned off 2720. FIG. 28 shows a confirmation 2810 on the device that the device has been fixed. As shown in FIG. 29, the post-fix summary is available, showing notes 2910, 2920 provided on the customer care session entered by the customer care representative.

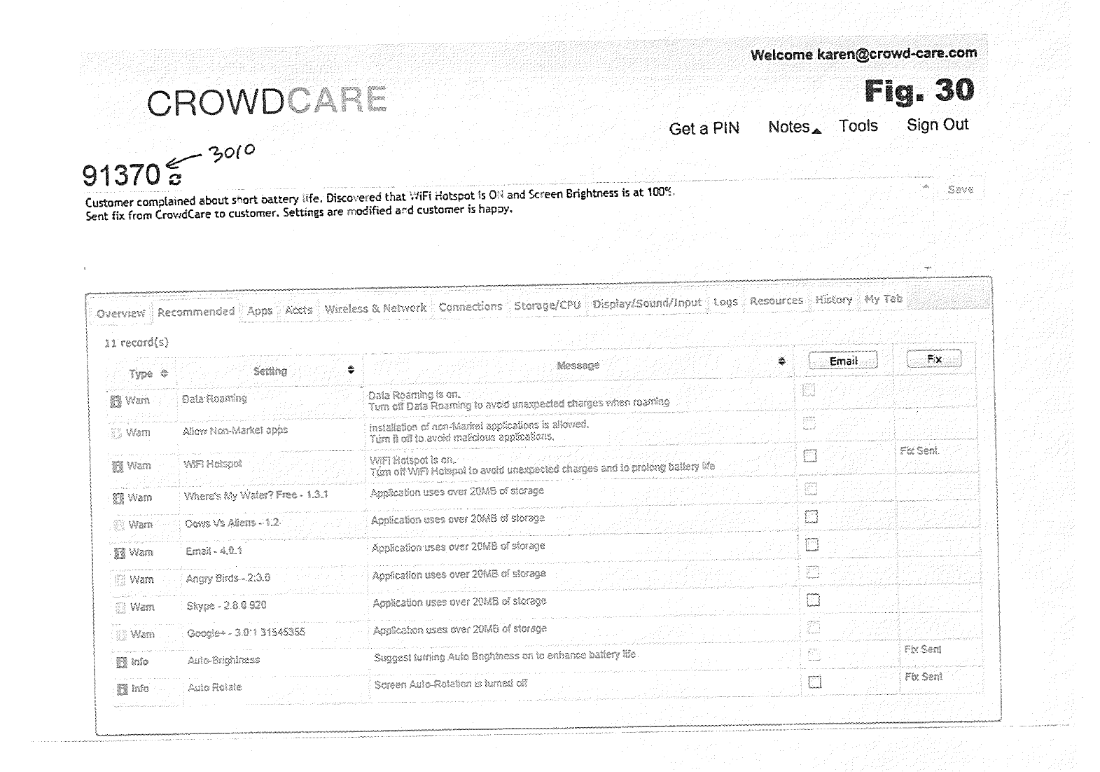

As shown in FIG. 30, this is saved in association with the PIN from the device 3010.

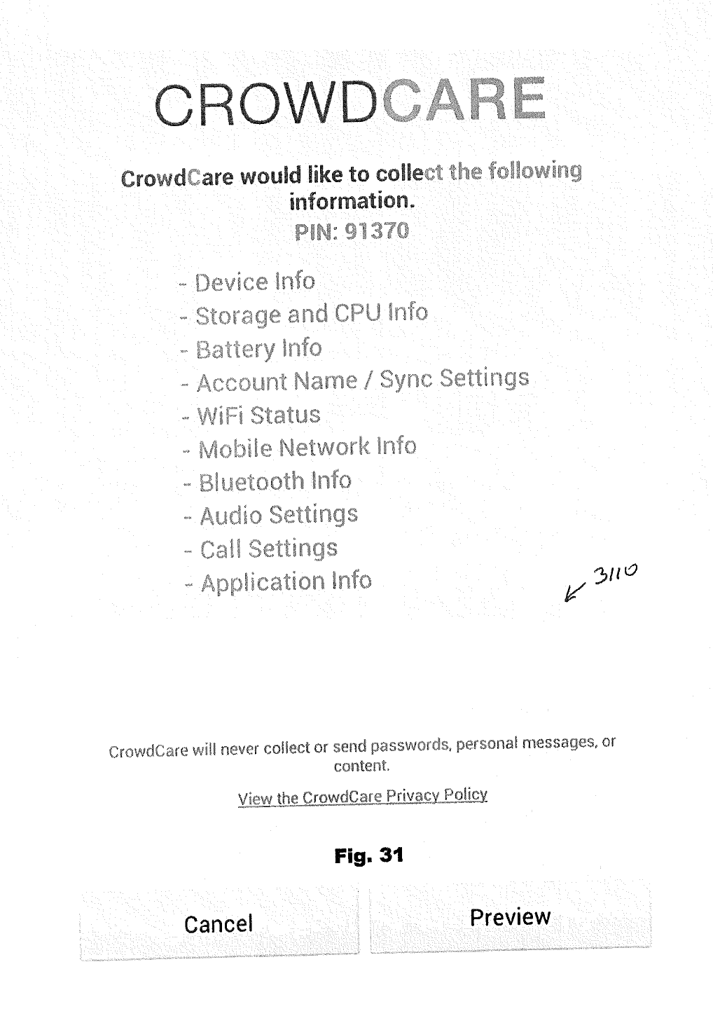

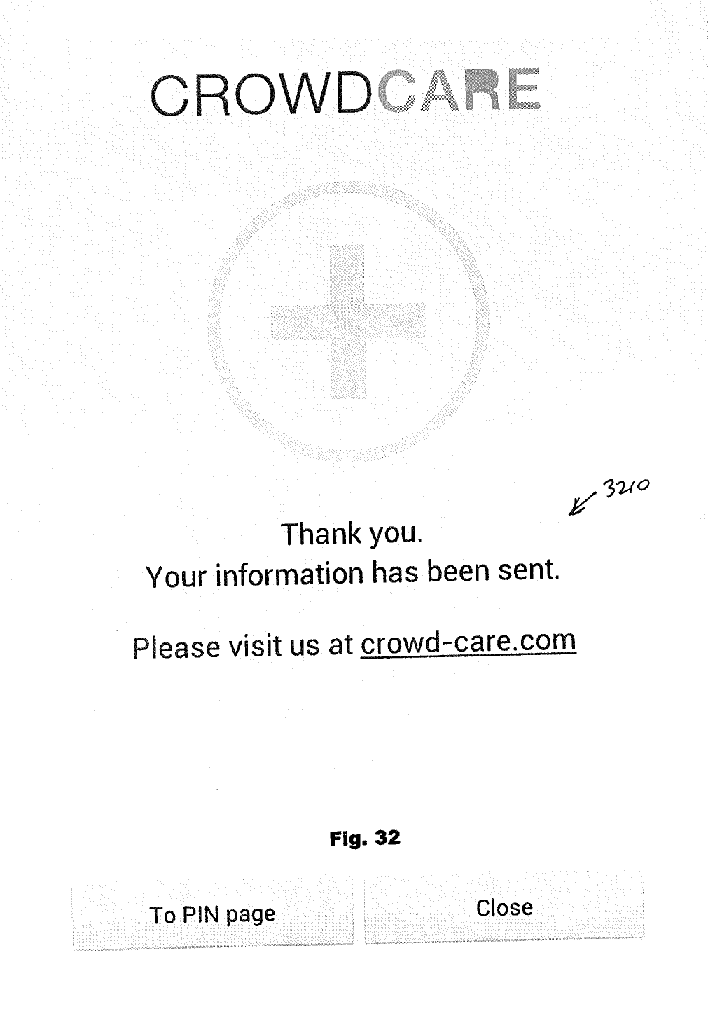

FIG. 31 shows a consent screen 3110 for taking a second (or subsequent) profile of the device, which is confirmed 3210 in FIG. 32.

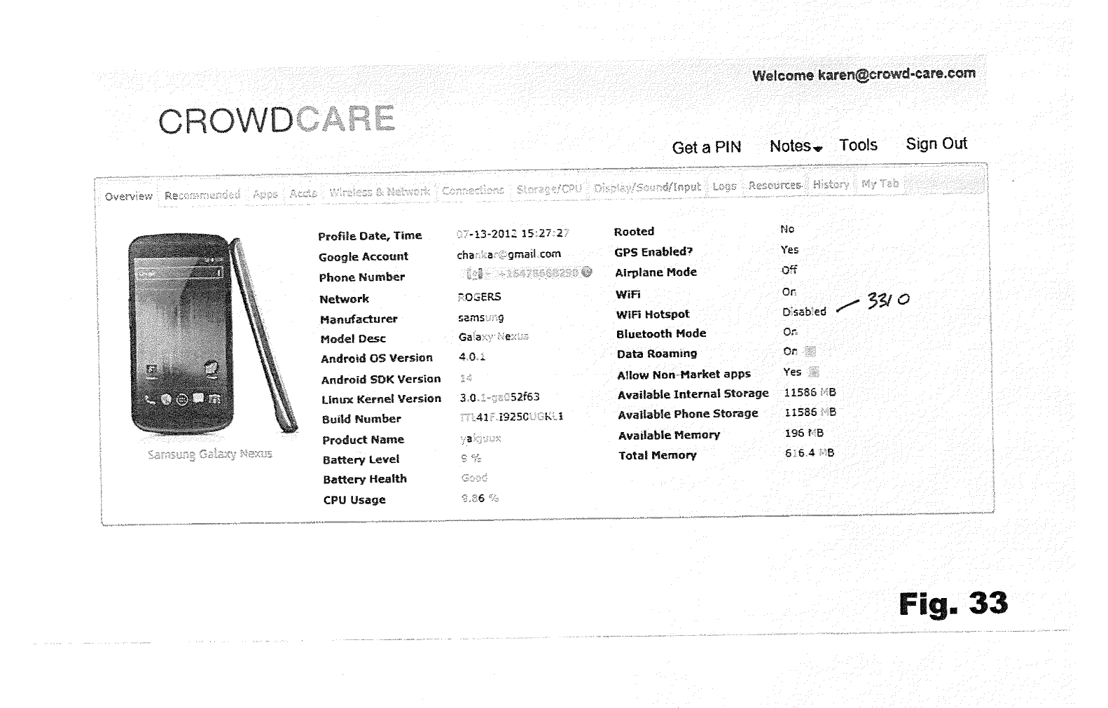

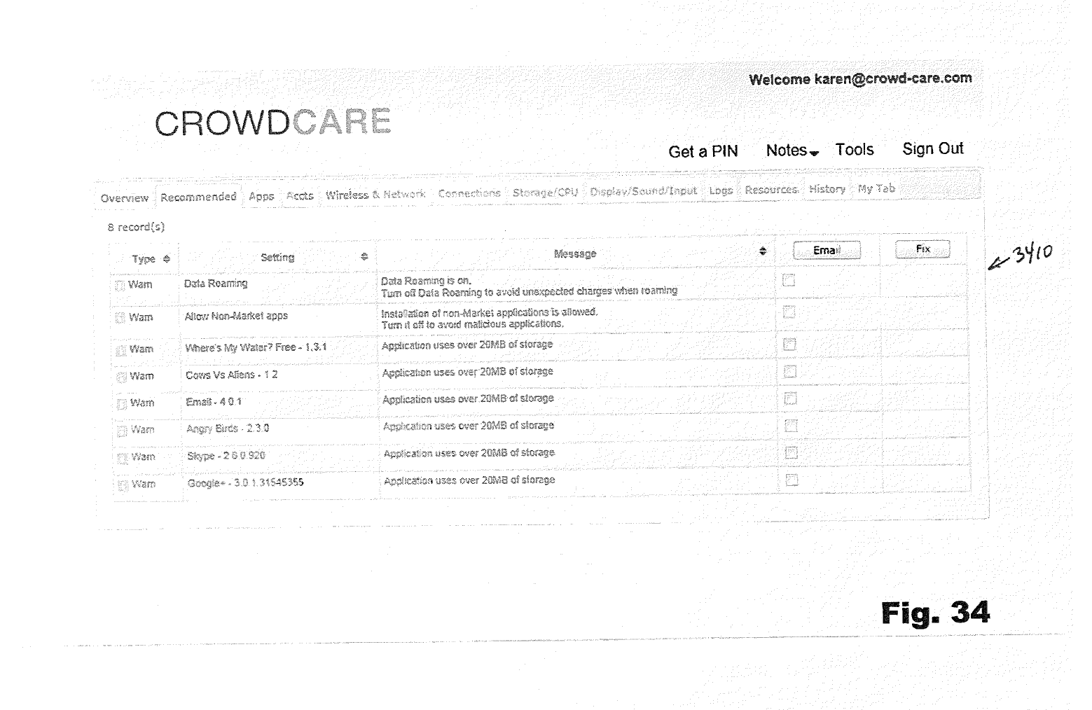

As shown in FIG. 33, the fixes that had been provisioned by the customer care representative are now shown as changed settings. For example, WiFi Hotspot has been shut off (disabled) 3310. Other recommendations may still be provided, as shown in screen 3410 in FIG. 34.

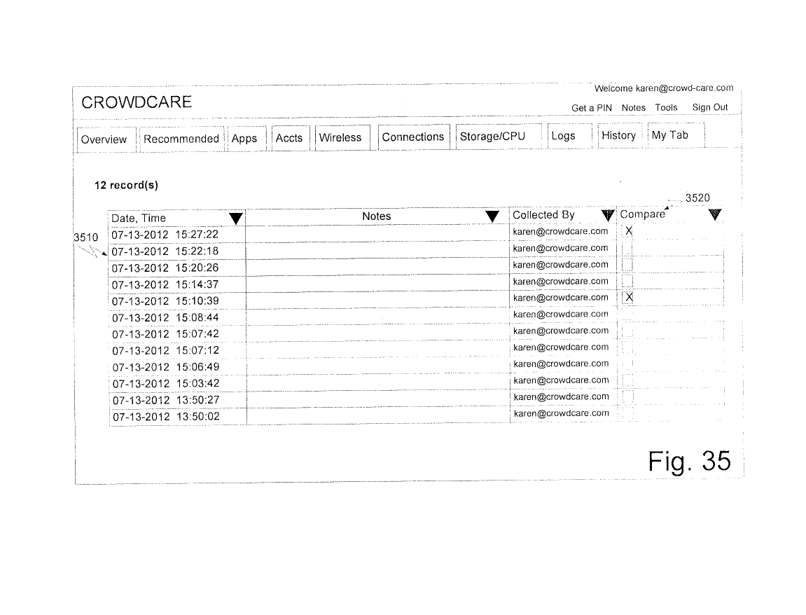

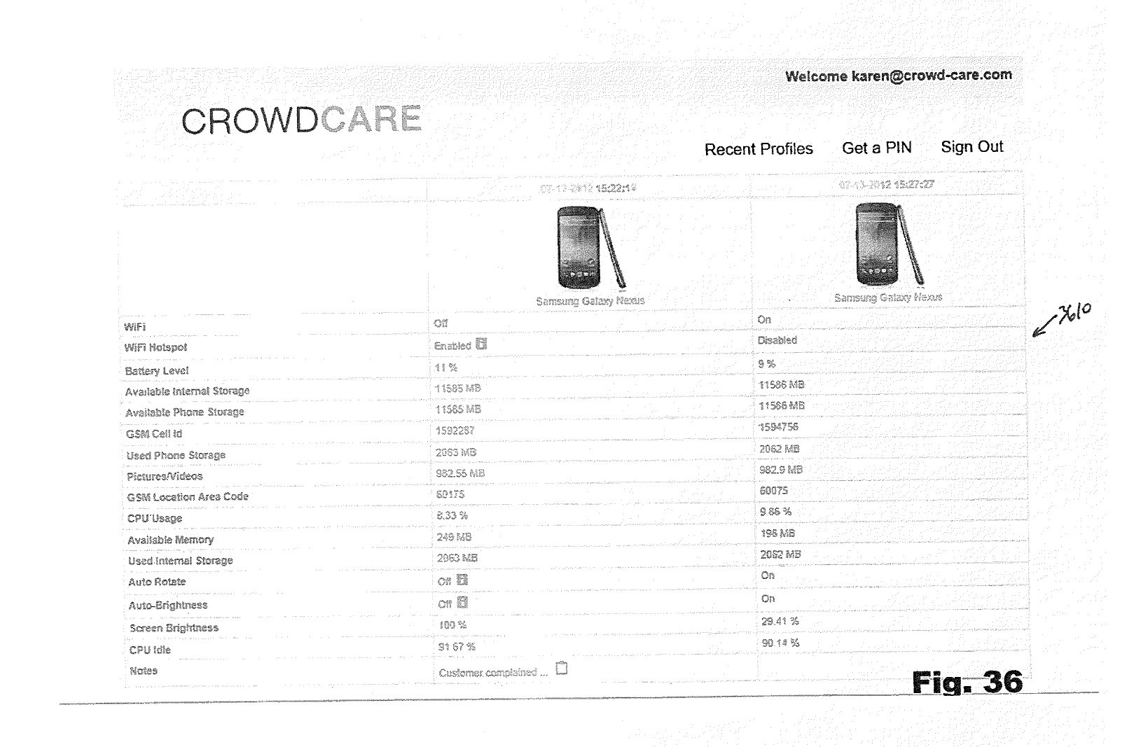

The new profile 3510 is accessible in the history, as shown in FIG. 35, and any of the profiles can be compared 3520. The comparison of the profiles (as shown in screen 3610 in FIG. 36) will not only inform the customer care representative as to what was changed, but also be used as the basis for generating an automatic proto-rule to enable future customer care to be provided by identifying certain issues which have been amended in the past, both on this device for other related devices, or other related settings issues. The latest two profiles can also be auto-compared as soon as any new profile is gathered for the individual device. These will allow the CSR to immediately know what has changed as soon as the profile is displayed.

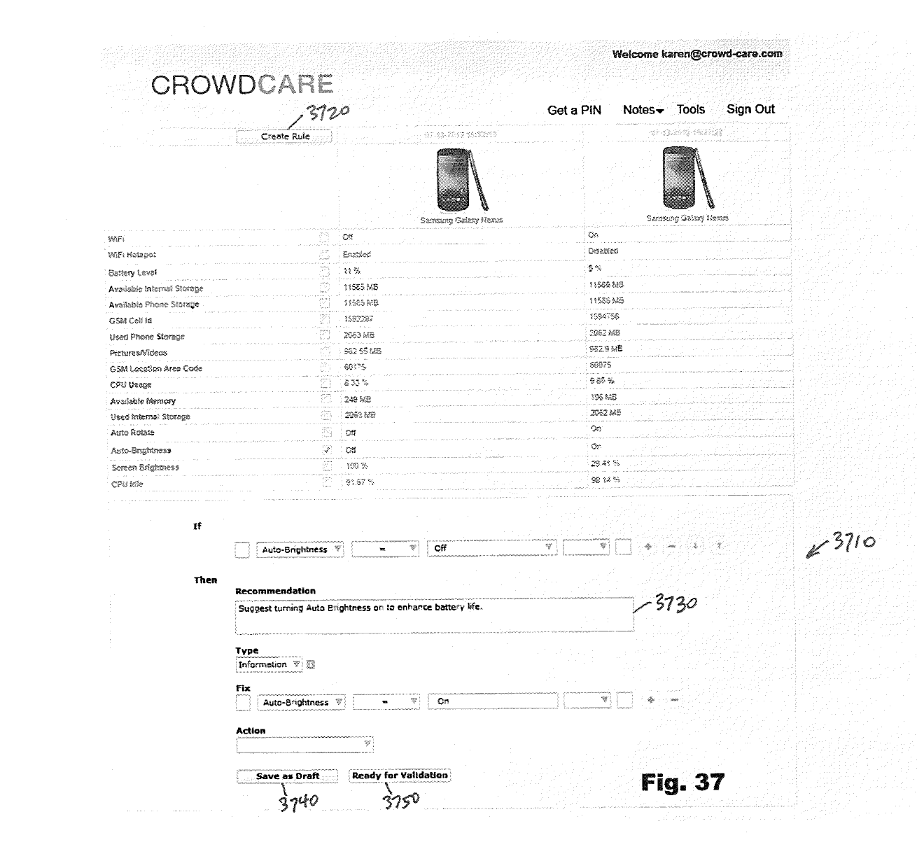

As shown in FIG. 37, a proto-rule editing window 3710 may be made accessible together with the compared device profiles. This rule editor may be auto-populated with one or more features from the profile comparison. In this case, the CSR has selected a specific parameter (Auto-Brightness) noted in the comparison between the device profiles. By the selection and clicking of the “Create Rule” button 3720, a rule editor begins to form the proto-rule associated with the profile comparison. Here, the proto-rule being established looks like this:

IF Auto-Brightness = Off
THEN recommendation is provided to “suggest turning Auto-Brightness
on to enhance battery life” AND
provide an optional fix to turn Auto-Brightness = On

The CSR may enter the text for the recommendation 3730, or this too may be auto-populated. This proto-rule may be saved as a draft 3740 and/or submitted for validation 3750.

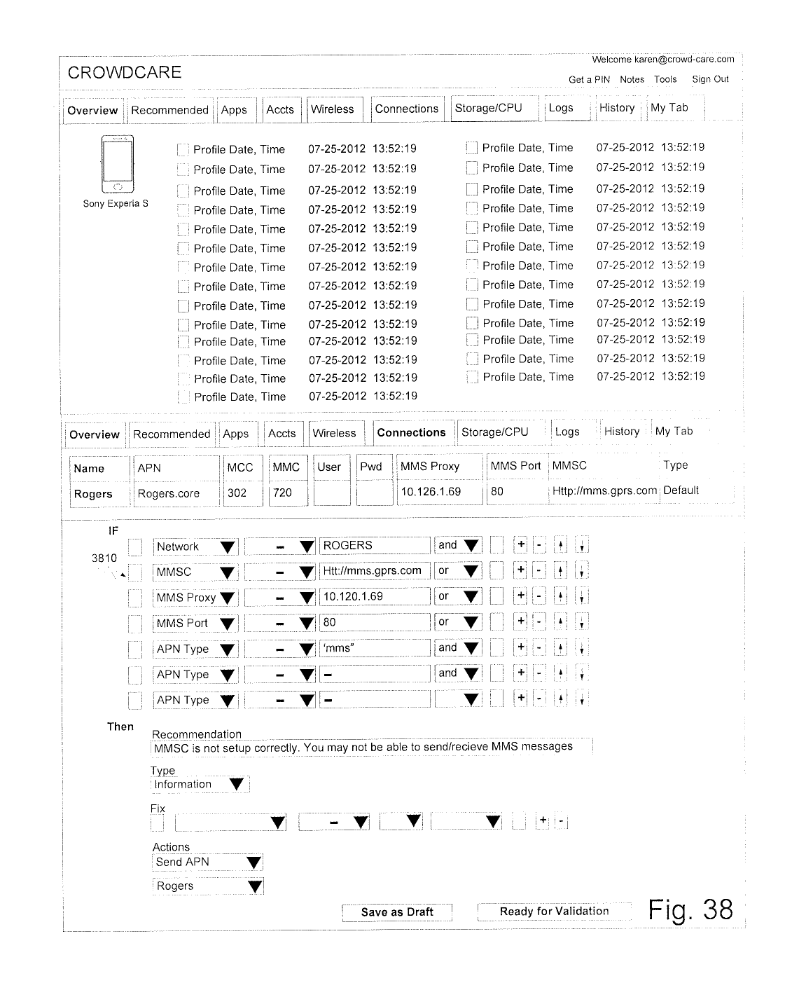

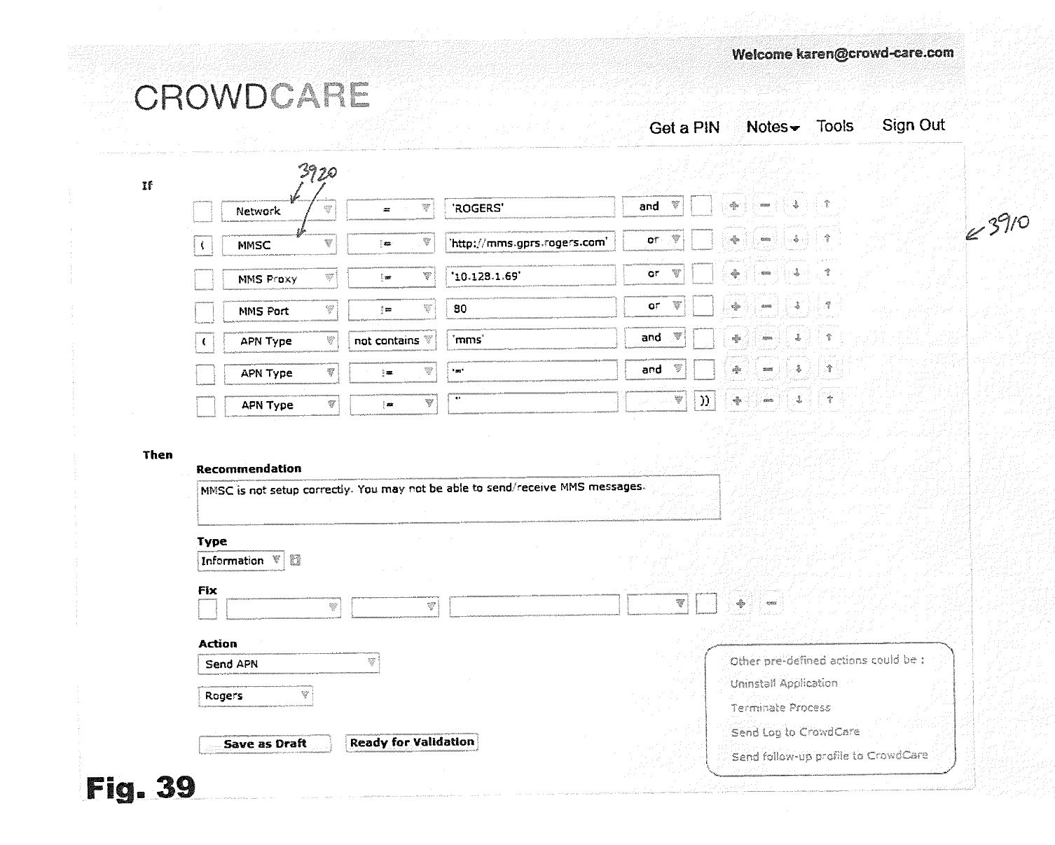

A more detailed rule creation in process is shown in FIG. 38, highlighting as a condition an incorrect MMSC 3810 for the particular device and network. FIG. 39 shows the rule editor 3910 for the proto-rule defined in FIG. 38.

The rule editor preferably includes drop-down selection lists 3920 or other form tools for standardized items (e.g. operators or certain types of standardized attributes) to allow for smoother, quicker entry and editing of rules.

A different (simplified) rule editor may also be directly available to the crowd for evaluation and direct editing or making suggestions for rule changes. In the case of self-care, the user may also be able to identify directly what changes seemed to help in order to allow rules to be developed.

It will be appreciated that various embodiments may comprise one or more special purpose or general purpose computers or server, each of which may include, but are not limited to, one or more processors, memories, storage devices, input-output devices and network interfaces. Likewise, the terms “computer” and “server” may be interchangeable in accordance with the above description. Furthermore, embodiments may be implemented as computer software instructions stored on a computer readable medium and executed in memory by processors on one or more of the computers or servers contemplated above. Although embodiments have been described as separate components, it will be understood that various components could be combined into a single computer or server, or implemented across multiple computers or servers all connected via a communications medium such as the Internet.

Numerous specific details are set forth herein in order to provide a thorough understanding of the exemplary embodiments described herein. However, it will be understood by those of ordinary skill in the art that these embodiments may be practised without these specific details. In other instances, well-known methods, procedures and components have not been described in detail so as not to obscure the description of the embodiments. Furthermore, this description is not to be considered as limiting the scope of these embodiments in any way, but rather as merely describing the implementation of these various embodiments.

1. A computer-implemented method of providing customer care to a user of a mobile device, comprising:
collecting at a computing device a first device profile of the mobile device;
receiving from the mobile device in communication with the computing device a problem report;
based on aspects of the first device profile displayed on a customer care interface on the computing device, providing a fix to the mobile device with respect to the problem report;
collecting at the computing device a second device profile of the mobile device;
determining using the computing device at least one difference between the first device profile and the second device profile;
automatically generating using the computing device a proto-rule for future fixes based on the problem report and the at least one difference; and
providing an editor at the computing device for editing the proto-rule.

2. The method of claim 1, further comprising seeking feedback from the user to determine if the fix addressed the problem report, and generating the proto-rule only if the feedback is positive.

3. The method of claim 2, wherein if the feedback is negative, attempting another fix of the mobile device.

4. The method of claim 1, wherein differences between the first device profile and the second device profile are displayed on the customer care interface.

5. The method of claim 1, wherein the proto-rule has an “IF . . . THEN” syntax.

6. The method of claim 5, wherein the “IF” portion of the proto-rule is based on the problem report and at least one aspect of the first device profile.

7. The method of claim 6, wherein the “THEN” portion of the proto-rule is based on the at least one difference.

8. The method of claim 1, wherein the first device profile is collected when a customer care session is initiated by the user.

9. The method of claim 1, wherein the first device profile is collected automatically at a predetermined time.

10. The method of claim 1, wherein the problem report is a request for device improvement or performance enhancement.

11. The method of claim 1, wherein the problem report is automatically triggered or generated on the mobile device.

12. The method of claim 1, wherein the fix comprises changing a setting or value in the device profile.

13. The method of claim 1, wherein the fix comprises providing the mobile device with access to at least one updated software module.

14. The method of claim 1, wherein the fix is implemented automatically following analysis of the first device profile.

15. The method of claim 1, wherein the fix is selectable from among a set of potential fixes displayed on the customer care interface.

16. The method of claim 1, further comprising identifying potential fixes with respect to the problem report by automated analysis having regard to a rule set.

17. The method of claim 16, wherein an edited proto-rule can be implemented such that the rule becomes part of the rule set used to identify potential fixes.

18. The method of claim 1, further comprising making the proto-rule available for editing by users distributed across a communications network.
